(19) United States
(12) Patent Application Publication
(10) Pub. No.: US 2025/0274233 A1
(43) Pub. Date: Aug. 28, 2025

(54) ORTHOGONAL TIME DOMAIN REFERENCE SIGNAL TRANSMISSION

(71) Applicant: Lenovo (United States) Inc., Morrisville, NC (US)

(72) Inventors: Sher Ali Cheema, Ilmenau (DE); Ahmed Hindy, Aurora, IL (US); Seyedomid Taghizadeh Motlagh, Oberursel (DE)

(73) Assignee: Lenovo (United States) Inc., Morrisville, NC (US)

(21) Appl. No.: 19/177,255

(22) Filed: Apr. 11, 2025

(51) Int. Cl. H04L 5/00; H04L 25/02; H04L 27/26; H04W 72/0446

(52) U.S. Cl. CPC H04L 5/0007; H04L 25/0222; H04L 27/2678; H04W 72/0446

(57) ABSTRACT

Various aspects of the present disclosure relate to orthogonal time domain reference signal transmission. A user equipment (UE) may receive signaling configuring a set of parameters corresponding to one or more orthogonal time domain reference signals (e.g., unique words (UWs) in a time domain). The UE supports multiple input multiple output (MIMO) transmission and reception using an orthogonal frequency division multiplexing (OFDM) waveform. The UE transmits or receives symbols in a time domain including the one or more orthogonal time domain reference signals based on the set of parameters and the OFDM waveform.

### TECHNICAL FIELD

The present disclosure relates to wireless communications, and more specifically to configuring reference signals.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive signaling configuring a set of parameters corresponding to one or more orthogonal time domain reference signals (e.g., unique words (UWs), demodulation reference signals (DMRSs)), where the UE supports multiple input multiple output (MIMO) transmission and reception using an orthogonal frequency division multiplexing (OFDM) waveform, and transmit or receive, based on the set of parameters and the OFDM waveform, symbols in a time domain including the one or more orthogonal time domain reference signals.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling configuring a set of parameters corresponding to one or more orthogonal time domain reference signals, where the UE supports MIMO transmission and reception using an OFDM waveform, and transmit or receive, based on the set of parameters and the OFDM waveform, symbols in a time domain including the one or more orthogonal time domain reference signals.

A method performed or performable by a UE for wireless communication is described. The method may include receiving signaling configuring a set of parameters corresponding to one or more orthogonal time domain reference signals, where the UE supports MIMO transmission and reception using an OFDM waveform, and transmitting or receiving, based on the set of parameters and the OFDM waveform, symbols in a time domain including the one or more orthogonal time domain reference signals.

In some implementations of the UE, the processor, and the method described herein, the UE, the processor, and the method may further be configured to, capable of, or operable to perform channel estimation measurements based on the one or more orthogonal time domain reference signals, where the UE receives the symbols, and transmit a report including the channel estimation measurements. In some implementations of the UE, the processor, and the method described herein, the UE receives the symbols, where the symbols include a data sequence, and where the UE, the processor, and the method may further be configured to, capable of, or operable to demodulate the data sequence using the channel estimation measurements. In some implementations of the UE, the processor, and the method described herein, the set of parameters includes at least one of a sequence associated with the one or more orthogonal time domain reference signals, a length associated with the one or more orthogonal time domain reference signals, a length of a cyclic prefix (CP) associated with a transmission including the one or more orthogonal time domain reference signals, or a location in a symbol in the time domain corresponding to the one or more orthogonal time domain reference signals. In some implementations of the UE, the processor, and the method described herein, the set of parameters includes a length of a CP, and where a length of the one or more orthogonal time domain reference signals is at least equal to the length of the CP. In some implementations of the UE, the processor, and the method described herein, the symbols include respective orthogonal time domain reference signals of the one or more orthogonal time domain reference signals, where lengths of the respective orthogonal time domain reference signals include a same value, and where the symbols span a slot in the time domain. In some implementations of the UE, the processor, and the method described herein, the symbols include respective orthogonal time domain reference signals of the one or more orthogonal time domain reference signals, where lengths of the respective orthogonal time domain reference signals include different values, and where the symbols span a slot in the time domain.

In some implementations of the UE, the processor, and the method described herein, the UE, the processor, and the method may further be configured to, capable of, or operable to receive additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals. In some implementations of the UE, the processor, and the method described herein, a set of symbols span a single time slot, where the symbols include a fraction of the set of symbols, and where the symbols include at least one of downlink data symbols, uplink data symbols, downlink control information (DCI) symbols, or uplink control information (UCI) symbols. In some implementations of the UE, the processor, and the method described herein, the symbols span a subset of time slots of a set of time slots, and where the symbols include at least one of downlink data symbols, uplink data symbols, DCI symbols, or UCI symbols. In some implementations of the UE, the processor, and the method described herein, to transmit or receive the symbols including the one or more orthogonal time domain reference signals, the UE, the processor, and the method may further be configured to, capable of, or operable to transmit or receive respective orthogonal time domain reference signals for a set of transmit antennas based on at least one code type of a set of code types, where the set of code types include of Barker codes, Golay codes, Zadoff-Chu sequences, and Walsh-Hadamard sequences.

In some implementations of the UE, the processor, and the method described herein, the set of parameters includes an indication of respective code types corresponding to the set of transmit antennas. In some implementations of the UE, the processor, and the method described herein, the set of parameters include the set of code types, and where the UE, the processor, and the method may further be configured to, capable of, or operable to select a code type of the set of code types, where the symbols are transmitted based on the code type, and transmit a report that indicates the code type. In some implementations of the UE, the processor, and the method described herein, respective orthogonal time domain reference signals associated with a set of UEs including the UE have a same code type, where the set of parameters includes a pseudo-random scrambling identifier, and where the UE, the processor, and the method may further be configured to, capable of, or operable to determine, based on the pseudo-random scrambling identifier, a set of initialization parameters corresponding to the respective orthogonal time domain reference signals, where the set of initialization parameters includes at least one of a distinct seed or a distinct initialization factor, and initialize the one or more orthogonal time domain reference signals with at least one of a slot number in a frame or a symbol number in the frame based on the set of initialization parameters. In some implementations of the UE, the processor, and the method described herein, the one or more orthogonal time domain reference signals includes a time domain reference signal associated with respective cyclic shifts corresponding to a set of transmit antennas. In some implementations of the UE, the processor, and the method described herein, the UE, the processor, and the method may further be configured to, capable of, or operable to receive additional signaling that indicates for the UE to apply an orthogonal cover code (OCC) to the one or more orthogonal time domain reference signals, where the additional signaling includes at least one of an OCC length, an OCC index, a symbol index in a slot in the time domain, or an indication to apply the OCC to one or more symbols in the slot, and apply, based on the additional signaling, the OCC to the one or more orthogonal time domain reference signals to obtain multi-port reference signals.

An NE (e.g., a base station) for wireless communication is described. The NE may be configured to, capable of, or operable to perform one or more operations as described herein. For example, the NE may be configured to, capable of, or operable to transmit signaling configuring a set of parameters corresponding to one or more orthogonal time domain reference signals, where the NE supports MIMO transmission and reception using an OFDM waveform, and transmit or receive, based on the set of parameters and the OFDM waveform, symbols in a time domain including the one or more orthogonal time domain reference signals.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling configuring a set of parameters corresponding to one or more orthogonal time domain reference signals, where the NE supports MIMO transmission and reception using an OFDM waveform, and transmit or receive, based on the set of parameters and the OFDM waveform, symbols in a time domain including the one or more orthogonal time domain reference signals.

A method performed or performable by an NE (e.g., a base station) for wireless communication is described. The method may include transmitting signaling configuring a set of parameters corresponding to one or more orthogonal time domain reference signals, where the NE supports MIMO transmission and reception using an OFDM waveform, and transmitting or receiving, based on the set of parameters and the OFDM waveform, symbols in a time domain including the one or more orthogonal time domain reference signals.

In some implementations of the NE, the processor, and the method described herein, the NE, the processor, and the method may further be configured to, capable of, or operable to receive a report including one or more channel estimation measurements based on the one or more orthogonal time domain reference signals, where the NE transmits the symbols. In some implementations of the NE, the processor, and the method described herein, the set of parameters includes at least one of a sequence associated with the one or more orthogonal time domain reference signals, a length associated with the one or more orthogonal time domain reference signals, a length of a CP associated with a transmission including the one or more orthogonal time domain reference signals, or a location in a symbol in the time domain corresponding to the one or more orthogonal time domain reference signals. In some implementations of the NE, the processor, and the method described herein, the set of parameters includes a length of a CP, and where a length of the one or more orthogonal time domain reference signals is at least equal to the length of the CP. In some implementations of the NE, the processor, and the method described herein, the symbols include respective orthogonal time domain reference signals of the one or more orthogonal time domain reference signals, where lengths of the respective orthogonal time domain reference signals include a same value, and where the symbols span a slot in the time domain. In some implementations of the NE, the processor, and the method described herein, the symbols include respective orthogonal time domain reference signals of the one or more orthogonal time domain reference signals, where lengths of the respective orthogonal time domain reference signals include different values, and where the symbols span a slot in the time domain.

In some implementations of the NE, the processor, and the method described herein, the NE, the processor, and the method may further be configured to, capable of, or operable to transmit additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals. In some implementations of the NE, the processor, and the method described herein, a set of symbols span a single time slot, where the symbols include a fraction of the set of symbols, and where the symbols include at least one of downlink data symbols, uplink data symbols, DCI symbols, or UCI symbols. In some implementations of the NE, the processor, and the method described herein, the symbols span a subset of time slots of a set of time slots, and where the symbols include at least one of downlink data symbols, uplink data symbols, DCI symbols, or UCI symbols. In some implementations of the NE, the processor, and the method described herein, to transmit or receive the symbols including the one or more orthogonal time domain reference signals, the NE, the processor, and the method may further be configured to, capable of, or operable to transmit or receive respective orthogonal time domain reference signals for a set of transmit antennas based on at least one code type of a set of code types, where the set of code types include of Barker codes, Golay codes, Zadoff-Chu sequences, and Walsh-Hadamard sequences.

In some implementations of the NE, the processor, and the method described herein, the set of parameters includes an indication of respective code types corresponding to the set of transmit antennas. In some implementations of the NE, the processor, and the method described herein, the set of parameters include the set of code types, where the NE, the processor, and the method may further be configured to, capable of, or operable to receive a report that indicates a code type of the set of code types, where the symbols are received based on the code type. In some implementations of the NE, the processor, and the method described herein, respective orthogonal time domain reference signals associated with a set of UEs have a same code type, where the set of parameters includes a pseudo-random scrambling identifier, where a set of initialization parameters corresponding to the respective orthogonal time domain reference signals are based on the pseudo-random scrambling identifier, and where the set of initialization parameters includes at least one of a distinct seed or a distinct initialization factor. In some implementations of the NE, the processor, and the method described herein, the one or more orthogonal time domain reference signals includes a time domain reference signal associated with respective cyclic shifts corresponding to a set of transmit antennas. In some implementations of the NE, the processor, and the method described herein, the NE, the processor, and the method may further be configured to, capable of, or operable to transmit additional signaling that indicates to apply an OCC to the one or more orthogonal time domain reference signals, where the additional signaling includes at least one of an OCC length, an OCC index, a symbol index in a slot in the time domain, or an indication to apply the OCC to one or more symbols in the slot.

### BRIEF DESCRIPTION OF THE DRAWINGS

FIG. 1 illustrates an example of a wireless communications system in accordance with aspects of the present disclosure.

FIG. 2 illustrates an example of a transmission diagram, in accordance with aspects of the present disclosure.

FIG. 3 illustrates an example procedure for transmission and reception, in accordance with aspects of the present disclosure.

FIGS. 4 through 8 illustrate examples of transmission diagrams, in accordance with aspects of the present disclosure.

FIG. 9 illustrates an example procedure for transmission and reception, in accordance with aspects of the present disclosure.

FIGS. 10 and 11 illustrate examples of signaling diagrams, in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a UE in accordance with aspects of the present disclosure.

FIG. 16 illustrates a flowchart of a method performed by an NE in accordance with aspects of the present disclosure.

### DETAILED DESCRIPTION

A wireless communications system may include one or more devices, such as UEs and NEs, that transmit and receive signaling using a waveform, including an OFDM waveform. An OFDM waveform divides a communication channel into multiple frequency resources in a frequency domain, referred to as subcarriers, such that the UEs and the NEs exchange data in parallel streams using the multiple subcarriers. In some cases, a transmitting device (e.g., a transmitter of a UE or an NE) may encode data onto orthogonal subcarriers in the frequency domain, perform an inverse Fourier transform on the encoded data to generate a time domain signal, and transmit the time domain signal. A receiving device (e.g., a receiver of a UE or an NE) may perform the reverse process to demodulate and decode a received time domain signal.

In some examples, the UEs and/or the NEs may add a portion of an end of an OFDM symbol of the time domain signal to a beginning of the OFDM symbol, which is referred to as a CP, to reduce inter-symbol interference and maintain orthogonality between subcarriers. An OFDM symbol refers to a transmission unit in the time domain that includes data encoded on multiple orthogonal subcarriers in the frequency domain. The CP introduces redundancy to a transmission, which leads to inefficient use of time-frequency resources due to a portion of available time and frequency resources being used by redundant information rather than data. In some examples, the UEs and/or the NEs may insert pilot symbols or pilot tones at defined locations (e.g., positions) in the time domain and in the frequency domain, respectively, to estimate a channel and to perform synchronization. However, inserting pilot symbols and pilot tones reduces spectral efficiency of the wireless communications system, as pilot symbols and pilot tones use time-frequency resources. Further, as the pilot tones are inserted in the frequency domain, the UEs and/or the NEs may transmit the pilot tones using increased power to enhance coverage, leading to increased power consumption at the UEs and/or the NEs.

As described herein, to reduce the inefficient use of time-frequency resources introduced by including CPs in symbols, a UE and/or an NE can insert one or more time domain reference signals (e.g., UWs in the time domain) for each symbol rather than CPs, which the UE and/or the NE can use for obtaining measurements for channel estimation. The NE can transmit one or more parameters to a UE that configure the time domain reference signals. For example, the parameters can include, but are not limited to, a sequence of the time domain reference signals, a length of the time domain reference signals, a CP length, and/or a location or placement of the time domain reference signals in respective symbols of a slot. The NE and/or the UE may transmit signaling that includes the time domain reference signals according to the parameters. The time domain reference signals may be orthogonal for respective transmit antennas if the UE and/or the NE are capable of MIMO communication (e.g., using multiple transmit antennas). The NE and/or the UE can measure the time domain reference signals for channel estimation. For example, if the NE transmits the time domain reference signals to the UE, then the UE can perform one or more channel estimation measurements using the time domain reference signals, including reference signal received power (RSRP) measurements, delay measurements, and/or Doppler measurements, among other example measurements.

In some cases, to improve spectral efficiency and power consumption related to transmission and reception of pilot tones in the frequency domain, an NE can dynamically insert pilot tones in the frequency domain. For example, an NE can transmit signaling to a UE including parameters that configure time domain reference signals and frequency domain reference signals, including the pilot tones in the frequency domain. The parameters can include, but are not limited to, a parameter that indicates whether the NE is transmitting pilot tones in the frequency domain for the UE to use for channel estimation, one or more frequency domain channel estimation parameters, time domain reference signal parameters, and/or a combine weighting average parameter, among other examples. The UE can receive the time domain reference signals and the frequency domain reference signals according to the signaling and can perform one or more channel estimation measurements using the time domain reference signals and the frequency domain reference signals. In some cases, the UE can provide the received reference signals and the parameters as input to a learning model and can receive the channel estimation measurements as output from the learning model. The UE can transmit a report to the NE including the channel estimation measurements.

By performing the described techniques, a device in a wireless communications system can improve the accuracy and efficiency (e.g., resource allocation and signaling overhead) of channel estimation by configuring orthogonal time domain reference signals for MIMO communication rather than using CPs in symbols. For example, the use of orthogonal time domain reference signals instead of CPs may reduce redundancy in transmissions, providing for an increased numerical quantity of resources to be allocated for data. Further, configuring both time and frequency domain reference signals improves spectral efficiency and signaling overhead by dynamically adjusting whether pilot tones are present in the frequency domain. Using a learning model to obtain channel estimation measurements may provide improve the accuracy of the channel estimation measurements, leading to improved link adaptation and increased reliability for communications.

Reference is made herein to communicating data or information, such as signaling of parameters and reference signals, among other communications, that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

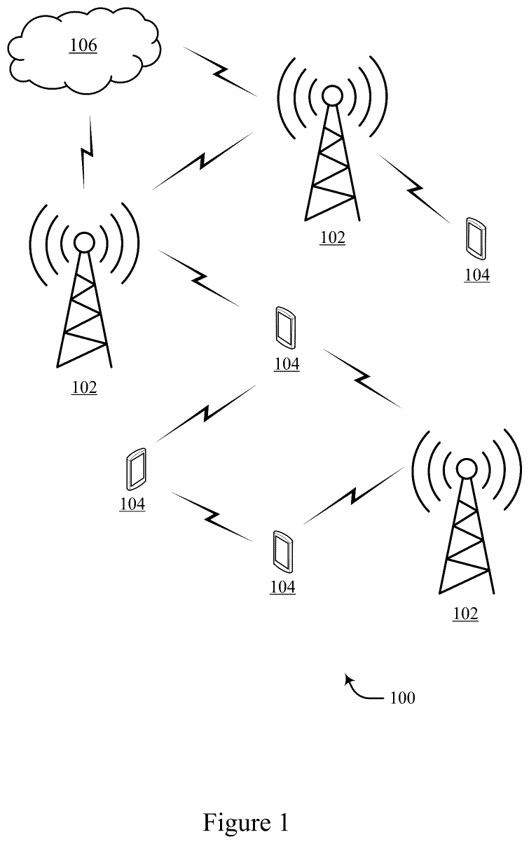

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal CP. A third numerology (e.g., μ=2) may be associated with a third subcarrier spacing (e.g., 60 kHz) and a normal CP or an extended CP. A fourth numerology (e.g., μ=3) may be associated with a fourth subcarrier spacing (e.g., 120 kHz) and a normal CP. A fifth numerology (e.g., μ=4) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 15 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHz), FR3 (7.125 GHz-24.25 GHz), FR4 (52.6 GHZ-114.25 GHZ), FR4a or FR4-1 (52.6 GHZ-71 GHz), and FR5 (114.25 GHZ-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The devices in the wireless communications system 100, which may be an example of a 5G NR communications system, may implement multi-carrier based waveforms. For example, one or more NEs 102 and/or one or more UEs 104 in the wireless communications system 100 may implement OFDM based waveforms for both uplink and downlink communications, such as a CP-OFDM based waveform for uplink and downlink communications and/or a discrete Fourier transform (DFT)-spread-OFDM (DFT-s-OFDM) waveform for uplink communications, among other examples. An OFDM based waveform refers to a modulation technique that divides a communication channel into multiple orthogonal subcarriers in a frequency domain, providing for parallel data transmission. A CP-OFDM based waveform is a type of OFDM waveform that includes a CP, which is a copy of the end portion of an OFDM symbol added to the beginning or start of the OFDM symbol. The CP may reduce inter-symbol interference and maintain orthogonality between subcarriers by introducing a guard interval or period in the symbol. A DFT-s-OFDM waveform is a type of OFDM-based waveform that applies a DFT operation to allocate (e.g., assign, partition, spread) the modulated data symbols across multiple subcarriers before performing an inverse fast Fourier transform (FFT) (IFFT) operation.

In some cases, such as for a CP-OFDM based waveform, a device (e.g., an NE 102 and/or a UE 104) may insert known or defined pilot tones or symbols at one or more positions in the frequency domain and at one or more symbol locations in the time domain. The devices can use the pilot symbols to perform channel estimation and for synchronization. Pilot tones may refer to reference signals inserted at defined positions in the frequency domain and time domain of a transmission. A receiving device (e.g., an NE 102 and/or a UE 104) can use the reference signals to estimate channel characteristics and perform timing alignment. Channel estimation may include an evaluation of the effects of the wireless channel on transmitted signals, including fading, multipath propagation, and interference. This estimation may be performed by comparing received pilot symbols with known transmitted values. Synchronization may refer to the process of aligning the timing and frequency of a receiver with a transmitter, which may provide for decoding received signals.

Inserting known pilot tones at one or more positions in the frequency domain and in the time domain provides for flexibility to change the density and placement of pilot tones or symbols based on channel conditions. However, pilot tones reduce spectral efficiency of the wireless communications system 100, as pilot tones consume bandwidth (e.g., in scenarios where dense pilot tones are used due to channel conditions). Moreover, a peak-to-average power (PAPR) of the pilot tones is relatively high (e.g., greater than a threshold value), as the pilot tones are inserted in the frequency domain. Thus, the devices use more power for pilot tones to enhance coverage. Additionally, or alternatively, for CP-OFDM the devices use an unknown CP for each symbol in a frame to have cyclic convolution. The CP is a redundant part of the data and is unknown to a receiver, using a percentage (e.g., 7%) of communication resources, including time-frequency resources, available to the devices in the wireless communications system 100 for transmission.

According to implementations, one or more of the NEs 102 and the UEs 104 are operable to implement various aspects of the techniques described with reference to the present disclosure. In some examples, to reduce inefficient use of communication resources related to pilot tones and CPs, as well as to reduce power consumption related to pilot tones, the Nes 102 and the UEs 104 in the wireless communications system 100 may implement a UW-OFDM based waveform. The UW-OFDM based waveform uses a known sequence (KS) or UW in a CP duration, whereas a CP duration is in the IFFT symbol duration. The UW-OFDM based waveform is a form of the CP-OFDM and can be regarded as an equivalent if an identity matrix is remultiplied with an IFFT matrix (e.g., instead of using any other matrix). The UW-OFDM based waveform provides for a redundant CP to be replaced by a UW, which is a known sequence inserted in the time domain and can be used for both synchronization and channel estimation. The UW may be an example of a reference signal and may additionally, or alternatively, be referred to as a time domain reference signal. The UW improves spectral efficiency at the wireless communications system 100, as the UW replaces the CP and can be used for channel estimation. The UW can reduce or minimize a signaling overhead related to a CP-OFDM based waveform and for pilot-based systems. Further, UWs are time domain sequences and have a low PAPR relative to frequency domain sequences. Thus, the devices in the wireless communications system (e.g., the NEs 102 and the UEs 104) can use one or more time domain reference signals (e.g., UWs) in a UW-OFDM based waveform or an enhanced CP-OFDM based waveform to measure channel estimations, for synchronization, and/or for sensing.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

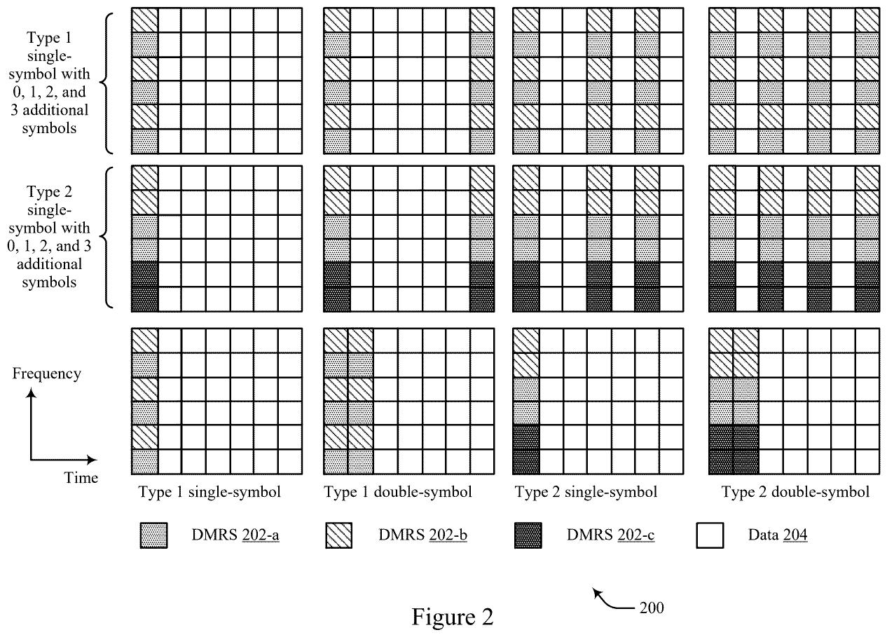

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 may be implemented by a UE and/or an NE, which may be an example of a UE 104 and an NE 102 as described with reference to FIG. 1.

In some cases, a UE and/or an NE can exchange (e.g., transmit and receive) one or more reference signals. A reference signal may refer to a signal or a sequence known to both a transmitter and a receiver, which the UE and/or the NE can use for channel estimation, synchronization, or other signal processing tasks. The UE and/or the NE can exchange different types of reference signals, including a DMRS. A DMRS may refer to a type of reference signal used for channel estimation and demodulation of data signals. DMRSs may be embedded within a data-carrying portion of a transmission and may be used by a receiver to estimate the channel characteristics and compensate for channel effects. For example, DMRS may be used to estimate phase and amplitude changes introduced by a wireless channel, enabling more accurate demodulation of the received signal. Additionally, or alternatively, an NE and/or a UE can use DMRSs for beamforming in MIMO systems, providing for a receiver to determine spatial characteristics of the channel and improve signal reception. In some cases, the NE and/or the UE may use the DMRSs for time and frequency synchronization, enhancing the overall performance of a wireless communications system.

In some cases, such as for an NR wireless communications system, a front-loaded DMRS structure is used as a baseline to achieve low-latency decoding. A front-loaded DMRS structure may refer to a configuration in which DMRSs are positioned at a start or at a beginning of a transmission time interval or slot, providing for faster channel estimation and enabling efficient data transmission in a remaining portion of the slot. A slot is an example of a resource in the time domain, which can be divided into a numerical quantity of smaller resources, referred to as symbols. In a time-frequency resource grid, a front-loaded DMRS can be located after a control region, followed by one or more data region. For example, the transmission diagram 200 includes one or more front-loaded DMRSs, including the DMRS 202-a, the DMRS 202-b, and the DMRS 202-c in a symbol at a beginning of a slot, and data 204. As soon as channel is estimated based on the front-loaded DMRS, a receiver can coherently demodulate data in the data region. The front-loaded DMRS structure is advantageous in decoding latency reduction for low-mobility scenarios, where channel coherence time is longer than the duration of the front-loaded DMRS.

However, allocating the front-loaded DMRS can degrade link performance at relatively high UE speeds (e.g., UEs with greater than a threshold processing speed) because channel coherence time becomes shorter. Although the channel information in the data region can be obtained by interpolation, the channel information accuracy diminishes with higher mobility. Therefore, the NE and/or the UE can use front-loaded DMRS patterns with different time domain densities, as shown in the transmission diagram 200. For example, to support high-speed scenarios, an NE can configure up to three additional DMRS occasions in a slot. The channel estimation at the receiver side can use the additional reference signals for more accurate channel estimation, for example, to perform interpolation between the DMRS occasions within a slot.

For high-speed scenarios, the time density of DMRS is increased to track fast changes in the radio channel. The NR defines two time domain DMRS structures, which differ in the location of the first DMRS symbol. A first DMRS structure is a mapping type A DMRS structure, in which the first DMRS is in the second and the third symbol of the slot and the DMRS is mapped relative to the start of the slot boundary, regardless of where in the slot the actual data transmission occurs. The mapping type A can be used if the data 204 occupies most of a slot (e.g., greater than a threshold numerical quantity of symbols of a slot). The NE and/or the UE can use the second or the third symbol in the downlink slot to locate the first DMRS occasion after a control resource set (CORESET) that is positioned at the beginning of a slot.

A second DMRS structure is a mapping type B DMRS structure, in which a first DMRS is positioned in a first symbol of the data allocation. The DMRS location is not given relative to the slot boundary, rather relative to where the data 204 is located. The mapping is intended for transmissions over a small fraction of the slot (e.g., less than a threshold numerical quantity of symbols) to support low latency and other transmissions that cannot wait until a slot boundary starts regardless of the transmission duration. An NE can configure a mapping type for a physical downlink shared channel (PDSCH) transmission dynamically as part of DCI to a UE. For a physical uplink shared channel (PUSCH), the mapping type is semi-statically configured.

The different time domain locations for DMRS mapping types (e.g., for a PDSCH) are single-symbol and double-symbol DMRS patterns. The purpose of the double-symbol DMRS is to provide a larger number of antenna ports than for a single-symbol structure. In some cases, the time domain location of the DMRS depends on the scheduled data duration. Multiple orthogonal reference signals can be generated in each DMRS occasion, including the DMRS 202-a, the DMRS 202-b, and the DMRS 202-c. Different DMRS patterns can be configured, which are separated in time, frequency, and code domains. The DMRS has two types, including a type 1 and a type 2, which are distinguished in frequency domain mapping and a maximum number of orthogonal reference signals. Type 1 can provide up to four orthogonal signals using a single-symbol DMRS and up to eight orthogonal reference signals using a double-symbol DMRS, whereas type 2 can provide 6 and 12 patterns depending on the number of symbols. The DMRS type 1 or type 2 is different from the mapping type A or type B, since different mapping types can be combined with different reference signal types. Reference signals can have relatively small power variations in the frequency domain (e.g., less than a threshold value) to provide for a similar channel-estimation quality for all frequencies spanned by the reference signal.

In some examples, a UE and/or an NE can generate a reference signal, including the DMRS 202-a, the DMRS 202-b, and/or the DMRS 202-c using a sequence. A sequence for reference signal generation may refer to a predetermined set of symbols or values used to create reference signals. Sequences for reference signal generation can be applied to create UWs or other time domain reference signals used in UW-OFDM or enhanced CP-OFDM systems. Examples of sequences that a UE and/or an NE can use for reference signal generation can include, but are not limited to, a Zadoff-Chu sequence, which has a constant amplitude and zero autocorrelation properties. Additionally, or alternatively, the sequences can include Gold sequences or Golay complementary sequences. The UE and/or the NE can select a sequence based on a criterion of a wireless communications system or a number (e.g., numerical quantity, amount) of antennas in a MIMO configuration.

In some cases, a sequence r (n) for reference signal generation (e.g., DMRS generation) is defined according to Equation 1:

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) , \qquad ( 1 )$$

where c (i) is a pseudo-random sequence. The pseudo-random sequence generator is initialized based on Equation 2:

$${c}_{init} = ( {2}^{17} ( {N}_{symb}^{s / o t} {n}_{s , f}^{μ} + l + 1 ) ( 2 {N}_{ID}^{{\overline{n}}_{SCID}^{λ}} + 1 ) + {2}^{17} ⌊ \frac{λ}{2} ⌋ + 2 {N}_{I D}^{{\overline{n}}_{SCID}^{λ}} + {\overline{n}}_{SCID}^{λ} ) mod {2}^{31} , \qquad ( 2 )$$

where l is an OFDM symbol number within the slot, n_{s,f}^{μ}, is the slot number within a frame, and N_{ID}⁰, N_{ID}¹∈{0, 1, . . . , 65535} are given by the higher-layer parameters scramblingID0 and scramblingID1, respectively, in a DMRS-DownlinkConfig information element (IE) if provided and the PDSCH is scheduled by a physical downlink control channel (PDCCH) using DCI format 1_1 or 1_2 with a cyclic redundance check (CRC) scrambled by a cell-radio network temporary identifier (RNTI) (C-RNTI), a modulation coding scheme (MCS)-C-RNTI (MCS-C-RNTI), or a configured scheduling (CS)-RNTI (CS-RNTI). In some case, N_{ID}⁰∈{0, 1, . . . , 65535} is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI. In some examples, No N_{ID}ⁿ^{_{SCID}}=N_{ID}^{cell}, otherwise n̅_{SCID}^{λ} is given by Equation 3:

$${\overline{n}}_{S C I D}^{λ} = \{ \begin{matrix}{n}_{S C I D} & λ = 0 or λ = 2 \\ 1 - {n}_{S C I D} & λ = 1\end{matrix} \qquad ( 3 )$$

if a higher-layer parameter DMRSdownlink-r16 in the DMRS-DownlinkConfig IE is provided. Otherwise, n̅_{SCID}^{λ} is given by n̅_{SCID}^{λ}=n_{SCID}. In some cases, λ is a defined code division multiplexing (CDM) group. The quantity n_{SCID}∈{0, 1} is given by a DMRS sequence initialization field, if present, in the DCI associated with the PDSCH transmission if DCI format 1_1 or 1_2 is used, otherwise n_{SCID}=0.

The UE can determine a PDSCH DMRS is mapped to physical resources according to a configuration type 1 or a configuration type 2 as given by the higher-layer parameter dmrs-Type. The UE can determine a sequence r(m) is scaled by a factor β_{PDSCH}^{DMRS} to conform with a defined transmission power and mapped to resource elements (k, l)_{p,μ} according to Equation 4:

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} ) \qquad ( 4 )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

where w_{f}(k′), wₜ(l′), and Δ are defined according to look up tables. In some cases, the resource elements are within common resource blocks allocated for a PDSCH transmission. The reference point for k is subcarrier 0 of a lowest-numbered resource block in CORESET 0 if the corresponding PDCCH is associated with CORESET 0 and Type0-PDCCH common search space and is addressed to SI-RNTI. Otherwise, the reference point for k is subcarrier 0 in common resource block 0. The reference point for l and the position l₀ of the first DMRS symbol depends on the mapping type. For PDSCH mapping type A, l is defined relative to the start of the slot and l₀=3 if the higher-layer parameter dmrs-TypeA-Position is equal to ‘pos3’ and l₀=2. For PDSCH mapping type B, I is defined relative to the start of the scheduled PDSCH resources and l₀=0.

One or more positions of the DMRS symbols are given by l̅ and duration l_{d}. For PDSCH mapping type A, l_{d} is the duration between the first OFDM symbol of the slot and the last OFDM symbol of the scheduled PDSCH resources in the slot. For PDSCH mapping type B, l_{d} is the duration of the scheduled PDSCH resources and according to one or more defined values (e.g., in one or more look up tables). For PDSCH mapping type A, the case dmrs-AdditionalPosition equals to ‘pos3’ is supported if dmrs-TypeA-Position is equal to ‘pos2.’ In some cases, l_{d}=3 and l_{d}=4 symbols are applicable if dmrs-TypeA-Position is equal to ‘pos2.’ In some examples, for a single-symbol DMRS, l₁=11, except if one or more conditions are fulfilled in which case l₁=12. The conditions can include the higher-layer parameter lte-CRS-ToMatchAround or additionalLTE-CRS-ToMatchAroundList being configured, the higher-layer parameter dmrs-AdditionalPosition is equal to ‘pos1’ and l₀=3, and the UE has indicated it is capable of additionalDMRS-DL-Alt.

For PDSCH mapping type B, if the PDSCH duration l_{d} ∈{2, 3, 4, 5, 6, 7, 8, 9, 10, 11, 12, 13} OFDM symbols for a CP or l_{d}∈{2, 4, 6} OFDM symbols for an extended CP, and the front-loaded DMRS of the PDSCH allocation collides with resources reserved for a search space set associated with a CORESET, l̅ can be incremented, such that the first DMRS symbol occurs immediately after the CORESET and until no collision with any CORESET occurs. If the PDSCH duration l_{d} is 2 symbols, then the UE is not expected to receive a DMRS symbol beyond the second symbol. If the PDSCH duration l_{d} is 7 symbols for a CP or 6 symbols for extended CP, then the UE is not expected to receive the front-loaded DMRS beyond the fourth symbol. Additionally, or alternatively, if one additional single-symbol DMRS is configured, then the UE expects the additional DMRS to be transmitted on the fifth or sixth symbol based on the front-loaded DMRS symbol being in the first or second symbol, respectively, of the PDSCH duration. Otherwise, the UE may expect that the additional DMRS is not transmitted.

If the PDSCH duration l_{d} is 12 or 13 symbols, then the UE is not expected to receive a DMRS symbol mapped to symbol 12 or later in the slot. For all other values of the PDSCH duration l_{d}, the UE is not expected to receive a DMRS symbol beyond the (l_{d}−1):th symbol. If the PDSCH duration l_{d} is 2 or 4 OFDM symbols, then a single-symbol DMRS is supported. If the higher-layer parameter lte-CRS-ToMatchAround or additionalLTE-CRS-ToMatchAroundList is configured, then the PDSCH duration l_{d}=10 symbols for a CP, the subcarrier spacing configuration μ=0, single-symbol DMRS is configured, and at least one PDSCH DMRS symbol in the PDSCH allocation collides with a symbol including resource elements as indicated by the higher-layer parameter lte-CRS-ToMatchAround or additionalLTE-CRS-ToMatchAroundList, then l̅ is incremented by one in all slots.

The time domain index l′ and the supported antenna ports p are defined according to Table 1. A single-symbol DMRS is used if the higher-layer parameter maxLength in the DMRS-DownlinkConfig IE is not configured. A single-symbol or double-symbol DMRS is determined by the associated DCI if the higher-layer parameter maxLength in the DMRS-DownlinkConfig IE is equal to ‘len2.’ In absence of CSI-RS configuration, and unless defined or configured, the UE may assume a PDSCH DMRS and a synchronization signal/physical broadcast channel (SS/PBCH) block to be quasi co-located (QCL) with respect to one or more of Doppler shift, Doppler spread, average delay, delay spread, or spatial receive parameters (e.g., if applicable). The UE may determine that the PDSCH DMRS within a same CDM group are QCL with respect to one or more of Doppler shift, Doppler spread, average delay, delay spread, or spatial receive parameters. The UE may determine that DMRS ports associated with a PDSCH are QCL with QCL Type A, Type D (e.g., if applicable), and average gain. The UE may determine that no DMRS collides with the SS/PBCH block.

TABLE 1
Parameters for PDSCH DMRS configuration type 1.

| | | |
|---|---|---|
| CDM | w_{f} (k′) | wₜ (l′) |

| p | group λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

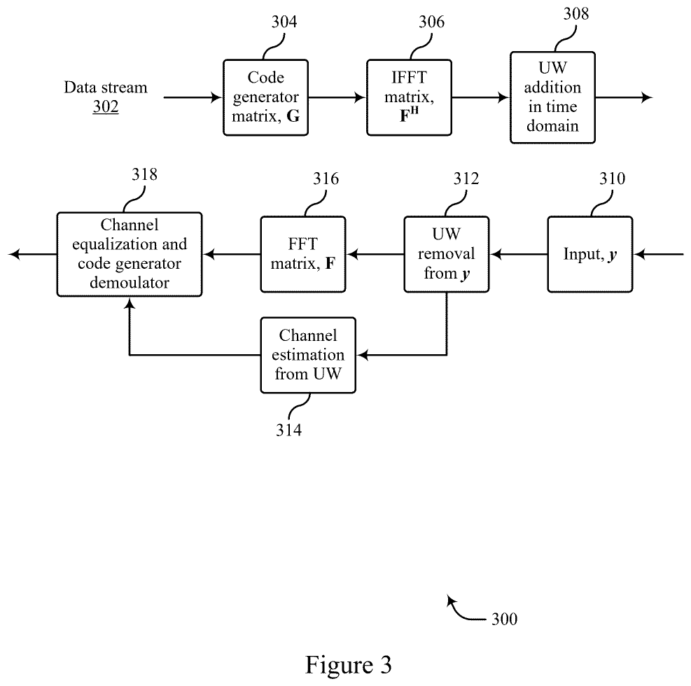

FIG. 3 illustrates an example procedure 300 for transmission and reception in accordance with aspects of the present disclosure. In some examples, the procedure 300 implements or is implemented by aspects of the wireless communications system 100 and the transmission diagram 200. For example, the procedure 300 may be implemented by a UE and/or an NE, which may be an example of a UE 104 and an NE 102 as described with reference to FIG. 1. A UE and/or an NE can encode and decode a data stream 302 according to the procedure 300.

In some examples, a transmitting device (e.g., a UE and/or an NE) can encode a data stream 302 for transmission. The data stream 302 may include information (e.g., data packets) to be transmitted, such as user data, control information, and/or other types of data. A transmitting device applies a code generator matrix 304 to the data stream 302. The code generator matrix 304 may apply various coding techniques, such as error correction coding or spreading codes, to enhance the robustness of the transmission. For example, the code generator matrix 304 may implement a low-density parity-check (LDPC) code or a turbo code to improve error resilience.

The transmitting device can pass the coded data through an IFFT matrix 306. The IFFT matrix 306 converts the frequency domain representation of the signal into a time domain representation for OFDM modulation, x_{d}. The transformation provides for using an available spectrum and managing multipath effects. Following the IFFT operation, the procedure 300 includes a UW addition in a time domain at 308. The UW addition in the time domain at 308 adds time domain reference signals, x_{UW}, referred to as UWs, to the time domain signal within the IFFT interval (e.g., an OFDM symbol duration). UWs are known (e.g., defined, preconfigured, predefined) sequences that are inserted in the time domain and can be used for various purposes, such as channel estimation, synchronization, or as reference signals. For example, UWs serve as time domain reference signals or DMRSs that can improve channel estimation accuracy or reduce signaling overhead when compared with a current CP-OFDM based waveform. The procedure 300 enables UW orthogonality in MIMO systems for estimating MIMO channels. The term UW or known symbol refers to a reference signal that is known to the transmitting device and the receiving device. A UW is at least of a CP duration (e.g., time, length, period). The output signal can be represented by a matrix that includes the UW in the time domain, according to Equation 5:

$$[ \begin{matrix}0 \\ {x}_{d}\end{matrix} ] + [ \begin{matrix}{x}_{UW} \\ 0\end{matrix} ] = [ \begin{matrix}{x}_{UW} \\ {x}_{d}\end{matrix} ] . \qquad ( 5 )$$

On the receiving side, a receiving device receives an input signal 310, which represents the received waveform that includes both the transmitted data (e.g., including the UWs) and any channel effects, h(t), or noise, n. The input signal can be represented according to Equation 6:

$$y = h ( t ) * [ \begin{matrix}{x}_{UW} \\ {x}_{d}\end{matrix} ] + n . \qquad ( 6 )$$

The input signal undergoes UW removal from input at 312. For example, the receiving device extracts the UWs from the received signal, which may be used for subsequent processing. The receiving device uses the extracted UWs for channel estimation from UW at 314. For example, the receiving devices uses the known UW sequences to estimate one or more channel characteristics, such as frequency response or timing offsets. The channel estimation information derived from the UWs provides more accurate or efficient channel state information (CSI) when compared with pilot-based estimation. The procedure 300 supports generating multiport DMRS signals using UWs, enhancing the ability of the receiving device and/or the transmitting device to perform channel estimation in MIMO configurations.

The signal after UW removal is processed by an FFT matrix 316. The FFT matrix 316 converts the time domain signal back into the frequency domain (e.g., reversing the IFFT operation performed at the transmitting device). The transformation equalizes the channel effects and recovers the original frequency domain representation of the data. The procedure 300 concludes by applying a channel equalization and code generator demodulator 318. The channel equalization and code generator demodulator 318 uses the channel estimation information obtained from the UWs to equalize the received signal, compensating for channel distortions. Additionally, or alternatively, the channel equalization and code generator demodulator 318 performs the inverse operations of the code generator matrix used at the transmitting device to recover the data stream 302.

By incorporating UWs as time domain reference signals, the procedure 300 provides for improved channel estimation accuracy, reduced signaling overhead, and enhanced flexibility in signal design compared with traditional OFDM based waveforms. For example, a UE and/or an NE can use the UWs in the time domain for use cases with relatively high mobility or rapidly changing channel conditions (e.g., greater than a threshold rate of change in channel conditions and/or greater than a threshold mobility). The procedure 300 supports a hybrid method to perform channel estimation using both frequency domain pilot tones and UWs that are inserted in the time domain, combining the advantages of both approaches for more robust and efficient channel estimation.

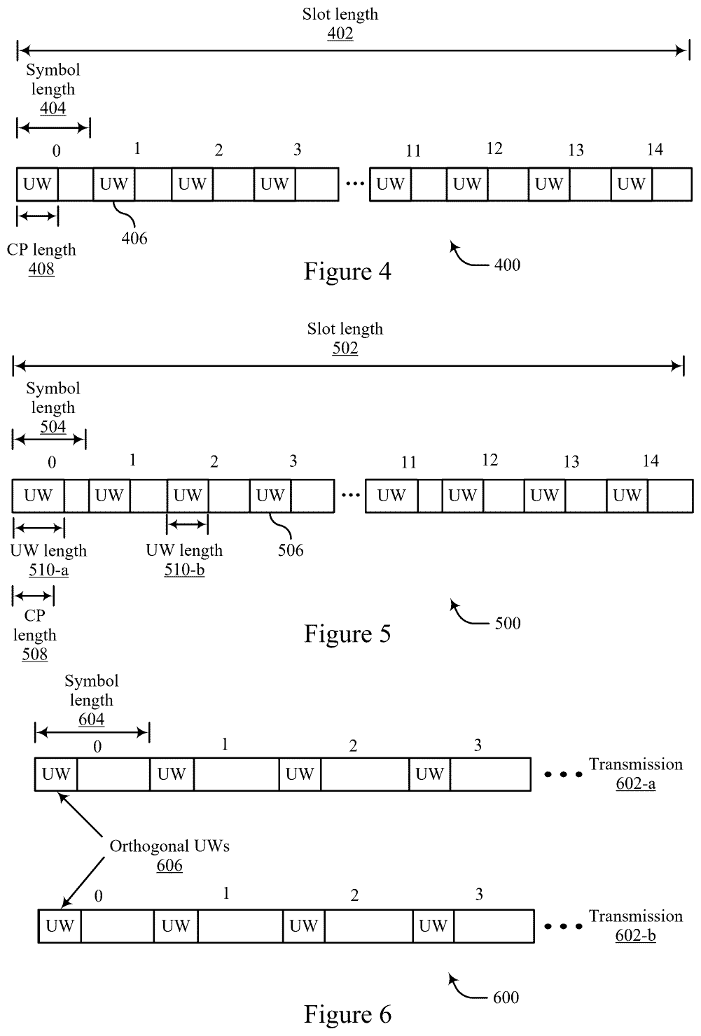

FIG. 4 illustrates an example of a transmission diagram 400 in accordance with aspects of the present disclosure. In some examples, the transmission diagram 400 implements or is implemented by aspects of the wireless communications system 100, the transmission diagram 200, and the procedure 300. For example, the transmission diagram 400 may be implemented by a UE and/or an NE, which may be an example of a UE 104 and an NE 102 as described with reference to FIG. 1.

In some cases, a UE and/or an NE can exchange (e.g., transmit and/or receive) one or more reference signals in the time domain, as shown in the transmission diagram 400. For example, a transmission from the UE and/or from the NE can span one or more resources in the time domain and in the frequency domain. The resources in the time domain can include a slot with one or more symbols. For example, the transmission can span a slot length 402 that includes one or more symbols, such as 15 symbols. Each symbol can have a symbol length 404 corresponding to the reciprocal of subcarrier spacing and can include a time domain reference signal inside the symbol length 404, referred to as a UW 406. The symbols may be symbols in an OFDM based waveform that uses an N-point FFT (N-FFT) for modulation and demodulation. The N-FFT symbol represents a time domain signal generated after applying an IFFT to N subcarriers in the frequency domain. The N-FFT symbol can include data, control information, and/or reference signals mapped to the subcarriers.

The UE and/or the NE can insert the UWs 406 in the time domain for each OFDM symbol in a frame. The UE and/or the NE can use the UWs 406 as DMRSs for channel estimation, for synchronization, or for one or more other purposes (e.g., measuring a quantity, including azimuth angle, delay etc.). The UW 406 can span a CP length 408, which is a defined portion of a symbol that is scheduled or allocated for a CP. For example, a length of the UWs 406 may be equal to or greater than a configured CP length 408 (e.g., a CP duration). However, UWs 406 may be part of a symbol length or duration and may not extend the symbol length beyond the length corresponding to the reciprocal of subcarrier spacing. The transmission diagram 400 can apply for control channels, data channels, or symbols for initial access.

In some cases, an NE can configure a UE with a set of parameters to indicate the reference signals in the time domain (e.g., the UWs 406). For example, the NE can transmit control signaling to the UE, including radio resource control (RRC) signaling, a medium access control-control element (MAC-CE), and/or a DCI that indicates the set of parameters. The set of parameters can include any numerical quantity of parameters that define the UWs 406. For example, the set of parameters can include, but is not limited to, one or more of a sequence of the UWs 406, a length of the UWs 406, a CP length 408, or a location or placement of the UWs 406 within a symbol or slot. The NE may implicitly or explicitly configure the type of UW sequence used for downlink or uplink transmission. Both the UE and NE may determine the UW sequence for correct channel estimation. The UE may be informed about the total UW length used as time domain reference signals (e.g., DMRSs). In some cases, if the UW length equals the CP length 408, then the configured CP length 408 may be implicitly assumed as the UW length for a time domain reference signal (e.g., DMRS). Additionally, or alternatively, the UE may be informed by the NE about the CP length common to all symbols in a frame (e.g., in addition to the UW length). The UE may be informed about the UW placement in a slot or frame. For example, the UE may be configured with one UW length for all symbols within a slot or different UWs of variable length in the slot. The UE may be configured with an exact position of the UW 406 to extract the correct portion of the received signal for correlation. By using UWs as both a CP and a time domain reference signal (e.g., DMRS) for channel estimation, the UE and/or the NE can improve channel estimation accuracy and reduce signaling overhead compared to traditional OFDM-based systems.

FIG. 5 illustrates an example of a transmission diagram 500 in accordance with aspects of the present disclosure. In some examples, the transmission diagram 500 implements or is implemented by aspects of the wireless communications system 100, the transmission diagram 200, the procedure 300, and the transmission diagram 400. For example, the transmission diagram 500 may be implemented by a UE and/or an NE, which may be an example of a UE 104 and an NE 102 as described with reference to FIG. 1.

In some cases, a UE and/or an NE can exchange (e.g., transmit and/or receive) one or more reference signals in the time domain, as shown in the transmission diagram 500. For example, a transmission from the UE and/or from the NE can span one or more resources in the time domain and in the frequency domain. The resources in the time domain can include a slot with one or more symbols. For example, the transmission can span a slot length 502 that includes one or more symbols, such as 15 symbols. Each symbol can have a symbol length 504 and can include a time domain reference signal, referred to as a UW 506. The symbols may be examples of an N-FFT symbol. The UE and/or the NE can insert the UWs 506 in the time domain for each OFDM symbol in a frame. The UE and/or the NE can use the UWs 506 as DMRSs for channel estimation.

In some cases, the UW 506 can span one or more different lengths. For example, the UW 506 can span duration greater than or equal to a CP length 508, such that the UW length 510-a is greater than a CP length 508 and a UW length 510-b is equal to a CP length 508. That is, the transmission diagram 500 illustrates an example of a dynamic or flexible UW configuration, in which the UW length may vary between symbols within a same slot. A UE and/or an NE can implement the transmission diagram 500 with varying lengths of UWs 506 if a channel delay spread approaches or exceeds a CP length 508 (e.g., leading to interference between payload data and the UW 506 or DMRS used for channel estimation).

In some cases, the NE may configure one or more symbols in a slot or subframe with a larger UW length (e.g., the UW length 510-a that is greater than the CP length 508) or with a smaller UW length (e.g., the UW length 510-b), as shown in FIG. 5. The NE can determine whether channel conditions may lead to increased interference and can configure a UE to transmit or receive the UWs 506 with the varying lengths by transmitting control signaling to the UE indicating the variation in the lengths of the UWs 506. In some cases, the NE can configure a same length of a UW 506 (e.g., a DMRS block) in the time domain across all symbols within a scheduled transmission and/or reception. In some other cases, the NE can configure different lengths of UWs 506 (e.g., DMRS symbols), such as one UW 506 (e.g., DMRS) having size N, while another UW 506 (e.g., DMRS) has a size M, where M is not always equal to N.

A numerical quantity of additional UWs 506 (e.g., in addition to the CP duration UW length) and corresponding positions may be semi-statically and/or dynamically configured by the NE based on channel conditions. To use different UW lengths for some symbols in the slot, the NE may configure parameters that indicate the respective UW lengths. For example, the parameters can include, but are not limited to, one or more of a symbol position in a slot or subframe in which where longer UWs 506 are used, a code generator matrix or an index from a set of code generator matrices to generate longer UWs 506, or a UW sequence used to generate the longer UWs 506. The NE can configure the parameters via higher layer signaling (e.g., RRC signaling), and can activate one or more of the parameters dynamically and/or semi-statically (e.g., DCI or MAC-CE). For example, the NE can transmit RRC signaling that configures multiple locations of longer UWs 506 in a slot length 502, and can transmit additional signaling, including a DCI and/or a MAC-CE, that activates or deactivates at least one of the locations of the longer UWs 506 for a subsequent transmission.

In some cases, the UW 506 may be applied to a subset of symbols in a set of symbols. The subset of symbols may correspond to a fraction of symbols associated with a time slot including multiple symbols. Additionally, or alternatively, the set of symbols can span multiple time slots, with the subset corresponding to symbols of a subset of time slots. Additionally, or alternatively, the subset of symbols may correspond to symbols carrying downlink data symbols, uplink data symbols, DCI symbols, UCI symbols, or any combination thereof. By providing for dynamic lengths of UWs 506, a UE and/or an NE can adapt to varying channel conditions and can improve performance for different types of transmissions within a same frame structure.

FIG. 6 illustrates an example of a transmission diagram 600 in accordance with aspects of the present disclosure. In some examples, the transmission diagram 600 implements or is implemented by aspects of the wireless communications system 100, the transmission diagram 200, the procedure 300, the transmission diagram 400, and the transmission diagram 500. For example, the transmission diagram 600 may be implemented by a UE and/or an NE, which may be an example of a UE 104 and an NE 102 as described with reference to FIG. 1.

In some examples, a UE and/or an NE can implement or support MIMO communications using multiple transmit or receive antennas. The transmission diagram 600 illustrates an example of MIMO communications for a transmission 602-a and a transmission 602-b. The transmission 602-a and the transmission 602-b may include symbols that span a symbol length 604 corresponding to reciprocal of subcarrier spacing. The transmission 602-a and the transmission 602-b can include one or more UWs that are orthogonal (e.g., the orthogonal UWs 606) and are added inside the symbol length or duration.

In some cases, a UE and/or an NE can use multiple transmitters and receivers for MIMO communications to send and receive data concurrently. For example, the UE and/or the NE can transmit and/or receive the transmission 602-a and the transmission 602-b, which include one or more orthogonal UWs 606, across multiple layers of a MIMO system for channel estimation over multiple antenna ports. The UE and/or the NE can use the transmission 602-a and the transmission 602-b to obtain channel information in at least one of an uplink direction (e.g., signaling from a UE to an NE) or a downlink direction (e.g., signaling from an NE to a UE). The orthogonal UWs 606 may be orthogonal if a cross-correlation between different UWs is zero or less than a threshold value. The orthogonality provides for improved separation and estimation of channel responses for different antennas or transmission layers. For example, if there are M transmit antennas, then the UWs satisfy one or more orthogonality conditions to enable estimating the spatial domain of the channel across the M transmit antennas. That is, if there are M transmit antennas, then the UWs u₁, u₂, . . . , U_{M} satisfy uᵢ^{H}uⱼ=0 for i≠j. The transmission diagram 500 illustrates an example of two transmit antennas (e.g., M=2).

In some cases, a multi-port UW may be used with a distinct UW across each antenna port. An NE and/or a UE can decompose multiple UW ports into a set of port groups, with each group associated with a distinct group of time slots. For example, the NE and/or the UE can decompose a 32-port UW into 4 port groups of size 8 each, with each group associated with a defined slot index or identifier. In some examples, the first group, second group, third group, and fourth group are associated with slots of identifier taking on the form 4m, 4m+1, 4m+2, and 4m+3, respectively, where m=0, 1, 2, 3, . . . , etc., corresponding to a periodicity value equal to the number of port groups. In some other examples, the periodicity is an integer multiple of the number of UW port groups. The NE and/or the UE can use separate UWs for each transmit antenna, where each UW is unique and orthogonal to other UWs. Additionally, or alternatively, the NE and/or the UE can use different types of codes with autocorrelation properties that satisfy a threshold value. The different types of codes can include, but are not limited to, Barker codes, Golay codes, Zadoff-Chu sequences, or Walsh-Hadamard sequences. For example, if an NE and/or a UE uses Golay codes for UWs for two transmit antennas, then the NE and/or the UE can insert one Golay code as UW1 for transmit antenna 1, and another Golay code as UW2 for transmit antenna 2. The receiver can correlate the received signal with UW1 to estimate the channel impulse response of transmit antenna 1 and correlate with UW2 to estimate the channel impulse response of transmit antenna 2.

The NE may configure or indicate to the UE which UW to use for each transmit antenna. For example, the NE can transmit signaling that indicates an index from a look-up table that defines the UW for a defined length. Additionally, or alternatively, the NE can select (e.g., choose) a UW for each transmit antenna from a predefined look-up table of one set of code types (e.g., either Golay, or Zadoff-Chu) that are used for defining UWs for multiple transmit antennas, and the UE correlates the received signal with all the codes within the same look-up-table. In some cases, different types of sequences may be specified or defined in look-up tables or by a sequence generation method. The NE may indicate to the UE the type of sequence to be used for UWs, which may be configured dynamically (e.g., using DCI), semi-statically (e.g., using a MAC-CE), or by higher layer signaling (e.g., RRC signaling).

Different sequences may be defined for different types of transmission channels, depending on coverage or use cases. For example, the NE and/or the UE may use a Golay sequence for control channels, a Barker sequence for data channels, or Zadoff-Chu sequences for initial access. If the NE and/or the UE is in a high coverage use case, then the NE and/or the UE may use a UW with low PAPR (e.g., less than a threshold value for PAPR), such as by using Golay sequences. For multi-user cases, the NE and/or the UE can use Zadoff-Chu sequences to generate the UWs. The NE may use different types of sequences as UWs for different transmit antennas. For example, with four transmit antennas, the NE may use two different Golay sequences for two antennas and two different Barker sequences for the other two antennas. The NE may indicate the UW assignment to the UE in control signaling for multiple antennas.

In some examples, the NE may indicate to UE what type of UWs are to be used for uplink transmission for different transmission layers. Additionally, or alternatively, the UE can select a sequence from a predefined list and can indicate to the NE the UW sequence used for different transmission layers. In some cases, UWs may be precoded to have orthogonality across multiple users. For example, the NE and/or the UE can design the UW sequences based on precoding, where precoding matrices may be separately designed for UW sequences or may use the same precoding matrices as used for data.

In some cases, different UWs across multiple users are based on a same sequence type, where each user in the multiple users is associated with a distinct seed, a distinct initialization factor, or any combination thereof. A value of the distinct seed and/or the initialization factor may depend on at least one of a slot number within a radio frame, an associated OFDM symbol number within the slot, or a pseudo-random scrambling identifier shared at both the UE side and the NE side. The UE may indicate in a report (e.g., CSI report) that indicates a precoding matrix for the UWs, since UWs are inserted in the time domain. If a codebook-based approach is used, then the UE may indicate an index for precoding from a look-up table, where the index may be a same or a different value than a precoding matrix indication (PCI) that is used for data transmission.

In some examples, different UEs are configured with (e.g., assigned by an NE) separate disjoint sets of orthogonal or different UW sequences. A UE may be configured with a set of sequences that can be used for a UW transmission, and the UE may determine a sequence from the set of sequence according to a defined (e.g., predetermined or indicated) mapping. For example, the NE can assign a number of distinct sequences, 2^{M}, to a UE as possible transmit UW sequences to be used during an uplink transmission grant. The UE determines the choice of the sequence according to M bits including information according to a pre-defined or configured definition. The M bits can include information indicating one or more of a UE category, a UE type, a battery condition, or an energy condition. Additionally, or alternatively, the M bits are used to uniquely identify a UE (e.g., as part of the initial access procedure). In some cases, a UE is preconfigured or indicated with a set of orthogonal or different UW sequences with which the UE may receive a downlink or a sidelink transmission (e.g., a sidelink transmission from another UE). For example, the number of distinct sequences, 2^{M}, is assigned to a UE as possible UW sequences used for a future downlink or sidelink reception by the UE. Upon determination by the UE of the used sequence, the UE decodes and interprets the associated M bits of the determined received UW sequence. The M bits can include a value for timing advance or frequency offset, as a feedback information from the transmitting device or node (e.g., gNB, NE) to the receiving device or node (e.g., UE).

In some cases, an NE and/or a UE can use one UW from a look-up table of a sequence type for all transmit antennas, where a cyclic shift (e.g., an offset) is applied to that UW for each of the transmit antennas. The cyclic shift provides for the UWs to remain orthogonal in the time domain. For example, an NE can configure a UE with one UW, u, where the UW for the ith transmit antenna would be uᵢ=circlarshift (u, τᵢ) with τᵢ being the cyclic shift for the ith transmit antenna. The NE can transmit signaling to the UE that configures the UE with a value of the cyclic shift.

In some examples, instead of using multiple separate UWs for each of the transmit antennas, the UE and/or the NE may use time reversal space time block codes (STBSC) (TR-STBC) or STBCs to spread the UW across multiple transmit antennas and time slots. STBCs may refer to a technique used in wireless communications to transmit multiple copies of a data stream across different antennas and time slots, improving the reliability of a data transmission. TR-STBCs may be a variant of STBCs that incorporate time reversal techniques. For example, for two transmit antennas, a transmitting device may implement an Alamouti STBCs, in which the transmitting device transmits a UW from a first antenna in a first time slot and a modified version of the UW (e.g., complex conjugate or time-reversed) from a second antenna in a second time slot. The UE and/or the NE may use different STBCs with different code rates. At the receiver side, a receiving device applies STBCs decoding and then applies a channel estimation algorithm (correlation based, least square, etc.). An NE can configure a UE with a type of method that is used to map a UW or multiple UWs to the transmit antennas. If STBCs are used, then the NE may also configure corresponding STBCs.

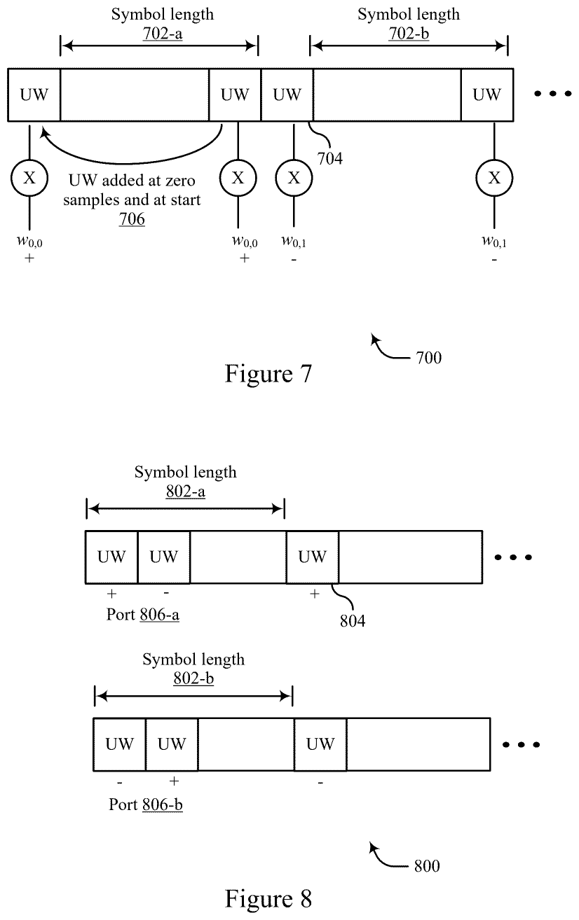

FIG. 7 illustrates an example transmission diagram 700 in accordance with aspects of the present disclosure. In some examples, the transmission diagram 700 implements or is implemented by aspects of the wireless communications system 100, the transmission diagram 200, the procedure 300, the transmission diagram 400, the transmission diagram 500, and the transmission diagram 600. For example, the transmission diagram 700 may be implemented by a UE and/or an NE, which may be an example of a UE 104 and an NE 102 as described with reference to FIG. 1.

In some cases, a UE and/or an NE can exchange (e.g., transmit and/or receive) one or more reference signals in the time domain, as shown in the transmission diagram 700. For example, a transmission from the UE and/or from the NE can span one or more resources in the time domain and in the frequency domain. The resources in the time domain can include a slot with one or more symbols. For example, the transmission can span a slot length that includes one or more symbols, such as a symbol with a symbol length 702-a and a symbol with a symbol length 702-b. In some examples, the symbol length 702-a may be the same as the symbol length 702-b. In some other examples, the symbol length 702-a may be different from the symbol length 702-b. The symbols can include one or more time domain reference signals, referred to as a UW 704. The symbols may be examples of an N-FFT symbol. The UE and/or the NE can insert the UWs 704 in the time domain for each OFDM symbol in a frame. The UE and/or the NE can use the UWs 704 as DMRSs for channel estimation. In some examples, the UE and/or the NE can apply OCCs to the UWs 704 to generate multi-port DMRSs. An OCC is a sequence that a UE and/or an NE can apply to reference signals to generate multiple orthogonal versions of a same base sequence. For example, a length-2 OCC may be applied to UWs 704 in two consecutive OFDM symbols to generate two orthogonal UWs 704. By applying OCCs to UWs 704, the UE and/or the NE may increase a number of available reference signal ports without increasing signaling overhead, as a same UW sequence can be reused across multiple symbols while maintaining orthogonality.

The UE and/or the NE can use the OCCs to generate additional ports for DMRSs (e.g., where the UWs 704 are used as DMRSs) by using different CDM groups. For example, the UE and/or the NE can use different CDM groups to implement OCCs with the UW 704 in a multi-port UW based structure. The UE and/or the NE can use a repetition of a UW 704 to apply the OCC to the UW 704 to generate multi-port DMRSs. Since a same UW 704 is used across the symbols in a slot to maintain cyclic convolution properties, the UE and/or the NE can apply the OCC to generate multiple ports of the same UW 704 across multiple users. At 706, the UE and/or the NE can add UWs 704 at zero samples and at a start of a symbol length 702-a. The transmission diagram 700 illustrates an example in which CPs in a CP-OFDM based waveform are replaced with known UWs 704 inserted at the beginning and end of OFDM symbols. For example, a UW 704 is inserted at zero positions and another UW 704 is inserted as a CP outside of the OFDM symbol duration, as indicated in FIG. 7. The use of UWs 704 (e.g., time domain reference signals) at the zero sample positions and at the start of the symbol length 702-a and the symbol length 702-b provides enhanced robustness due to low cross-correlation and PAPR characteristics of the UWs 704. Additionally, or alternatively, the use of UWs 704 provides for backward compatibility with CP-OFDM systems when an identity matrix is used, without changes to frame structure numerology.

An NE and/or a UE can define a length of an OCC code based on a number of symbols including UWs 704. Thus, the NE and/or the UE can generate ports according to the number of symbols including UWs 704, were at the most a slot-level OCC may be used for slot level ports for DMRSs with a UW 704. For example, if a number of symbols including UWs 704 in the slots is two, then a length two OCC may be used as to have cyclic convolution. A start and end of the symbol can include a same UW 704. If a code or port is assigned or configured to a UE, then the UE applies the code or port across a set of configured slots by repeating the code and applying the code to consecutive allocated symbols or slots. For example, if a UE is configured with two slots and a port with length 2 OCC code, then the UE applies the same code to the UWs 704 of both slots. In some cases, a DFT based sequences of various length may be used to generate multi-port UW based structures. DFT based sequences are flexible in that any number of OCC length may be generated. Additionally, or alternatively, the UE and/or the NE can use other orthogonal codes, such as Walsh-Hadamard sequences, to generate orthogonal ports, offering flexibility in terms of OCC length and orthogonal port generation.

FIG. 8 illustrates an example transmission diagram 800 in accordance with aspects of the present disclosure. In some examples, the transmission diagram 800 implements or is implemented by aspects of the wireless communications system 100, the transmission diagram 200, the procedure 300, the transmission diagram 400, the transmission diagram 500, the transmission diagram 600, and the transmission diagram 700. For example, the transmission diagram 800 may be implemented by a UE and/or an NE, which may be an example of a UE 104 and an NE 102 as described with reference to FIG. 1.

In some cases, a UE and/or an NE can exchange (e.g., transmit and/or receive) one or more reference signals in the time domain, as shown in the transmission diagram 800. For example, a transmission from the UE and/or from the NE can span one or more resources in the time domain and in the frequency domain. The resources in the time domain can include a slot with one or more symbols. For example, the transmission can span a slot length that includes one or more symbols, such as a symbol with a symbol length 802-a and a symbol with a symbol length 802-b. In some examples, the symbol length 802-a may be the same as the symbol length 802-b. In some other examples, the symbol length 802-a may be different from the symbol length 802-b. The symbols can include one or more time domain reference signals, referred to as a UW 804. The symbols may be examples of an N-FFT symbol. The UE and/or the NE can insert the UWs 804 in the time domain for each OFDM symbol in a frame. The UE and/or the NE can use the UWs 804 as DMRSs for channel estimation.

In some examples, if a length of a UW 804 is extended in a symbol, then the UW 804 is extended such that an additional UW is included that is a repetition a first UW. The UE and/or the NE may generate different ports (e.g., the port 806-a and the port 806-b, or a port 1000 and a port 1001) across the UW 804 in a symbol or across symbols in the slot. In some cases, a number of ports generated corresponding to the multi-port UW is proportional to the number of transmission layers. The transmission layers correspond to data carried over a PDSCH or a PUSCH. A first multi-port UW corresponding to a PDSCH may correspond to an OCC with a first length (e.g., 14), and a second multi-port UW corresponding to PUSCH corresponds to an OCC with a second length. In some cases, the second length is smaller than the first length (e.g., the second length is 7).

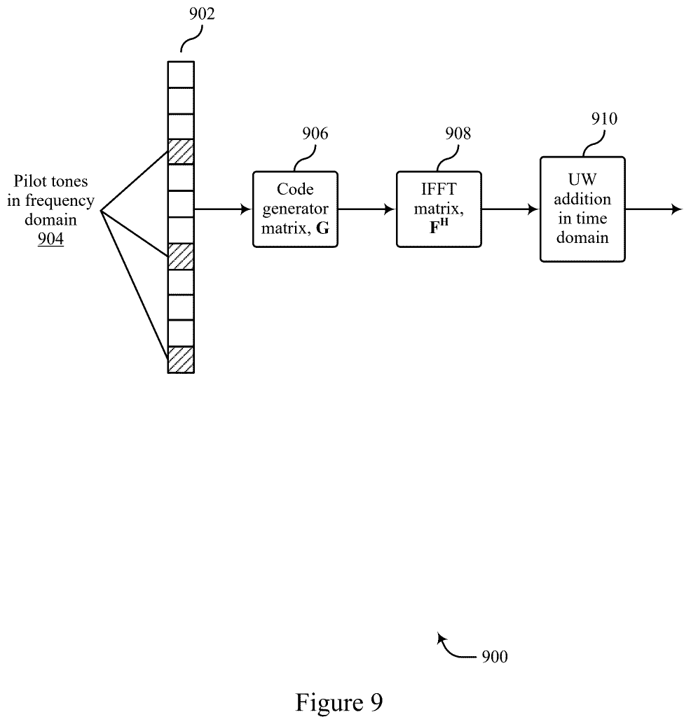

FIG. 9 illustrates an example procedure 900 for transmission and reception in accordance with aspects of the present disclosure. In some examples, the procedure 900 implements or is implemented by aspects of the wireless communications system 100, the transmission diagram 200, the procedure 300, the transmission diagram 400, the transmission diagram 500, the transmission diagram 600, the transmission diagram 700, and the transmission diagram 800. For example, the procedure 900 may be implemented by a UE and/or an NE, which may be an example of a UE 104 and an NE 102 as described with reference to FIG. 1.

In some examples, a transmitting device (e.g., a UE and/or an NE) can encode a data stream 902 for transmission. The data stream 902 may include information (e.g., data packets) to be transmitted, such as user data, control information, and/or other types of data. In some examples, an NE can configure a UE to include one or more pilot tones in a frequency domain 904 in the data stream 902. The NE configures time and frequency domain reference signals for channel estimation. The time domain reference signals can include one or more UWs, as described with reference to FIGS. 2 through 8, and the frequency domain reference signals can include or be based on the pilot tones in the frequency domain 904. The UE and/or the NE can insert time domain symbols at least in a CP duration in the time domain, and the insertion can be based on channel estimation conditions or sensing procedures. The UE and/or the NE can insert the pilot tones in the frequency domain 904 dynamically before application of a code generator matrix 906 to the data stream 902. Thus, the UE and/or the NE can leverage improvements in channel estimation resulting from inserting UWs (e.g., low noise sensitivity) and the pilot tones in the frequency domain 904 (e.g., improved frequency resolution).

A transmitting device applies a code generator matrix 906 to the data stream 902 including the pilot tones in the frequency domain 904. The transmitting device can pass the coded data through an IFFT matrix 908. Following the IFFT operation, the procedure 900 includes a UW addition in a time domain at 910. The UW addition in the time domain at 910 adds time domain reference signals to the time domain signal within the IFFT interval (e.g., an OFDM symbol duration).

The NE can configure one or more different types of frequency domain reference signals (e.g., DMRS) at a UE. In some cases, an OFDM symbol may or may not include pilot tones in the frequency domain 904 in a sub-slot, slot, subframe, frame, or any other resource in the time domain. The NE can transmit signaling including one or more parameters to configure both time and frequency domain reference signals for channel estimation. The parameters can include, but are not limited to, one or more of an indication whether pilot tones in frequency domain are configured for channel estimation, frequency domain channel estimation parameters (e.g., pilot densities, DMRS symbol position, starting position of DMRS), time domain reference signal parameters (e.g., UW length, UW sequence, UW mapping to transmit antenna), or a combine weighting average parameter.

For example, a UE and/or an NE may use a DMRS structure (e.g., similar to an NR DMRS structure) for frequency domain reference signals, including a front-loaded DMRS structure in the time-frequency resource grid. The front-loaded DMRS can be located after a control region and can be followed by a data region. For each slot, the DMRS symbol position is defined (e.g., preconfigured or predefined), whereas the NE may define different pilot densities in a frequency grid (e.g., how many pilot tones are there in an OFDM symbol) and in time domain (e.g., how many OFDM symbols in a slot use pilot tones). In some cases, the UE and/or the NE may implement a flexible (e.g., dynamic) insertion of the pilot tones in the frequency domain 904. For example, the NE can configure a UE with a symbol position in a sub-slot or in a slot that includes frequency domain reference signals. There may not be a fixed time domain symbol position for reference signals in a slot that are used for channel estimation or for some other position.

In some cases, based on UE reporting, the NE may determine to configure frequency domain reference signals and corresponding parameters. The UE may indicate implicitly or explicitly a report requesting one or more frequency domain reference signals (e.g., the pilot tones in the frequency domain 904) and indicating one or more related parameters. For example, based on a CSI report, the NE may determine one or more channel conditions and include the pilot tones in the frequency domain 904 in addition to, or as an alternative to, time domain reference signals.

In some cases, a UE and/or an NE can use a dedicated procedure to choose (e.g., select) lengths of one or more UWs for the time domain and symbols for the pilot tones in the frequency domain 904. The NE configures the pilot tones in the frequency domain 904 with various densities along with the UWs in the time domain. For example, based on the UE reporting, the NE selects a configuration of the pilot tones in the frequency domain 904 for the UE. The NE can configure one or more slots including symbols with frequency domain symbols (e.g., the pilot tones in the frequency domain 904) with different densities. The UE upon reception of the configuration can implement methods to estimate channel conditions (e.g., using UW, using the pilot tones in the frequency domain 904 with different configured densities). The UE estimates a combination of pilot tones with the UW and indicates the combination in a report to the NE. Based on the report, the NE may configure a combination of time and frequency domain reference signals (e.g., a best combination of UWs and the pilot tones in the frequency domain 904). The configuration can indicate to perform channel estimation using UWs and/or a combination of UWs and the pilot tones in the frequency domain 904. If the UE and/or the NE uses a combination of UWs and the pilot tones in the frequency domain 904 for channel estimation, then the configuration can also include an indication of a density of the pilot tones in the frequency domain 904.

In some cases, when time and frequency domain channel estimation are configured, the UE and/or the NE can use a weighting factor for combining time and frequency channel estimates. The weighting factor may be configured by the NE, determined by the UE (e.g., up to UE implementation), and/or based on the UE reporting the factor. The weighting factor may depend on a reliability of a chosen method (e.g., UW based channel estimation or frequency domain channel method). For example, H_{UW} is the frequency domain channel estimates that are derived using time-based UWs (e.g., using correlation based, least square based, Kalman filtering or minimum mean square error (MSE) (MMSE) based approaches) and H_{FD} is the channel estimates derived by implementing an approach using frequency domain pilots. A receiving device (e.g., a receiver at a UE and/or an NE) combines both estimates using a weighted fusion approach, where the combine channel estimates is based on Equation 7:

$${H}_{Com} = α {H}_{UW} + ( 1 - α ) {H}_{FD} , \qquad ( 7 )$$

where α is a weighting factor. The NE and/or the UE can use different α values depending on the reliability of the method. For example, the NE and/or the UE can use MSE criterion to select a value of α as

$$α = \frac{{σ}_{FD}^{2}}{{σ}_{FD}^{2} + {σ}_{UW}^{2}} ,$$

where σ_{FD}² and σ_{UW}² are the estimation variances of a frequency domain channel estimation method and a UW based channel estimation method.

In some examples, the NE implements a procedure to determine one or more UE capabilities for channel measurements based on time domain reference signals (e.g., UWs) and/or based on frequency domain reference signals (e.g., the pilot tones in the frequency domain 904). In a capability report, a UE can indicate to the NE which measurement types (RSRP, delay, Doppler measurements, etc.) the UE can perform or that the UE supports for different types of reference signals (e.g., a frequency domain reference signal, UWs in the time domain, or a hybrid combination of frequency domain reference signals and time domain UWs). In some cases, the UE indicates a supported processing delay in the capability report. The processing delay is associated with each measurement quantity for each of the reference signal types. The processing delay indicates at least a minimum time window for reporting of a measurement quantity for each of the reference signal types.

In some examples, the NE and/or the UE implement a measurement and reporting procedure for measurement and reporting of a quantity associated with time domain UWs, with frequency domain reference signals, and/or with measurements by combining both frequency domain and time domain reference signals. In some examples, the measurement and reporting configuration for the purpose of measurement is determined (e.g., determined by the NE, indicated or signaled to the UE) after the capability indications by the UE for performing channel measurement based on type of reference signals. In some cases, the NE configures a measurement quantity that is associated with one or more of the time domain UW, the frequency domain reference signal, or any combination thereof. For example, based on the UE capability, the NE may send a configuration for reporting of measurement quantity (e.g., RSRP) based on the frequency domain reference signals, send a configuration for reporting of the same measurement quantity (e.g., RSRP) based on time domain UWs, and/or send another configuration for reporting of a same measurement quantity (e.g., RSRP) based on a combined used of time and frequency reference signals.

In some cases, based on the capability exchange, the configuration includes one or more parameters for each association. The parameters can include, but are not limited to, a delay time corresponding to the reporting delay time (e.g., configuring a reporting occasion based on reference signal type) and a resolution by which the quantity is reported. The configurations for different types of reference signals may differ in parameters (e.g., in report resolution and report timing). In some examples, the measurements can be any type of channel estimation measurement or any sensing or positioning measurement, including one or more of detection or presence or energy of a path, path delay, doppler, azimuth angle, or zenith angle. In some cases, based on the received configuration, the UE sends a report to the NE. The report can include an indication of the measurement report generated based on time domain UW, the frequency domain reference signal (e.g., the pilot tones in the frequency domain 904), or any combination thereof. In some examples, the UE determines an estimation of a measurement quantity (e.g., path detection or path parameters estimation) jointly via the one or more of the time domain UW sequences and frequency domain reference signal. For example, the UE determines the estimation using a learning model, which may be an example of an artificial intelligence (AI) model and/or a machine learning (ML) model.

In some examples, the UE and/or the NE can use a learning model to generate one or more time domain reference signal (e.g., UW) parameters and one or more frequency domain reference signal parameters for a measurement quantity for a given channel condition. For each measurement quantity, the parameters can include, but are not limited to, a time domain reference signal (e.g., UW) density, a frequency domain reference signal (e.g., pilot tones in the frequency domain 904) density, a type of frame structure to be used, whether to use frequency domain reference signals in addition to time domain reference signals, and whether a hybrid approach is to be used. The time domain reference signal density indicates one or more time domain reference signal lengths for the time domain reference signals. For example, each time domain reference signal in a slot can share a same time domain reference signal length (e.g., greater than or equal to a CP length), as described with reference to FIG. 4. In some other examples, the time domain reference signals in a slot can have different time domain reference signal lengths (e.g., by repeating or increasing the length of the time domain reference signals in some symbols), as described with reference to FIG. 5.

In addition to time domain reference signals used in a frame structure, the frequency domain reference signal may be included for some channel conditions and for enhancing the accuracy of some measurement quantities. The density of the frequency domain reference signals for each measurement quantity for a give channel can be configured and/or generated by the learning model. The frame structure can include a UW-OFDM based frame structure or a CP-OFDM based frame structure with UW insertion as CPs. The frame structure can be configured or generated by the learning model for a given channel condition and for each of the measurement quantities. The learning model can generate an indication of whether time domain reference signals are sufficient for channel estimation, or whether to include frequency domain reference signals. Additionally, or alternatively, the learning model can generate an indication of whether to use a hybrid approach with both time and frequency domain reference signals for a measurement quantity, then what sort of technique is to be use for combining. What would be the optimal weights for combining frequency domain and time domain estimates.

In some examples, the NE and/or the UE can use a learning model to estimate (e.g., predict, infer, obtain) one or more measurements (RSRP measurements, L1 measurements, path measurements of energy or power, delay, doppler, azimuth angle, zenith angle, etc.). In some examples, the learning model may be a neural network or other algorithm that takes as input various parameters related to the wireless communication system. For example, the NE and/or the UE provide information as input to the learning model, and the leaning model generates the measurements from the input. The input can include, but is not limited to, a frequency domain reference signal pattern, a configuration of the frequency domain reference signal pattern, a configuration of the time domain reference signals, the time domain received signal at the receiving device (e.g., baseband time domain signal prior to FFT), the frequency domain received signal at the receiving device (e.g., post-FFT baseband signal at the configured frequency points), and/or one or more of the other parameters.

In some cases, the UE sends a report to the NE based on the learning model output. The report can include the input and/or the output of the learning model. In some cases, a UE receives a configuration from the NE to acquire labeled data samples for different measurement quantities (RSRP, delay, Doppler, channel estimates, etc.) for subsequent training of learning models. The NE may configure the UE with full or higher density frequency domain reference signals and different sets of time domain reference signals to estimate a near optimal estimate (e.g., a labeled data sample, an expected estimate) of a measurement quantity. The configuration may also include an indication to the UE to store the measured labeled data samples for obtaining subsequent reference signal parameter, for learning model training, and/or for future reporting purposes.

In some cases, if the UE obtains the labeled data samples, then the NE configures the UE with another set of parameters. The set of parameters differ from the configuration for obtaining the labeled data samples and include reduced frequency domain reference signal density and/or time domain reference signal density. Once the triggering of training of learning model is indicated to the UE and the UE receives the other set of parameters for training the learning model, the UE uses the stored labeled data samples of the measurement quantity to train (e.g., update, fine-tune) the learning model. In some cases, the NE may include in the configuration a training triggering mechanism indication, where the UE either is configured explicitly to initiate the learning model training based on the configuration parameters or the UE may initiate learning model training autonomously. The training can include updating one or more parameters (e.g., weights, biases) of the learning model using the labeled data samples in a supervised learning approach. For supervised learning using the labeled data samples, the UE may implement backpropagation to adjust the model weights and minimize the difference between predicted and actual data samples.

In some cases, once the training of the learning model is triggered either by explicit signaling from an NE or by a UE, the UE estimates the error of the measured quantity by using the labeled data sample and learning model training estimates based on the other set of parameters. The UE reports the error to the NE and receives a new set of parameters to update the learning model. For example, the NE may configure a reduced density frequency symbols initially but based on UE reporting of error from the model training, the NE may increase the density. In some cases, the NE configures various densities of frequency domain reference signals and time domain reference signals in one configuration. The UE uses the different set of configured parameters in training the learning model, where the learning model takes input for both time and frequency reference signals and generates a shared output. Once the training is completed, the UE reports back the updated set of parameters at given channel conditions for a measurement quantity.

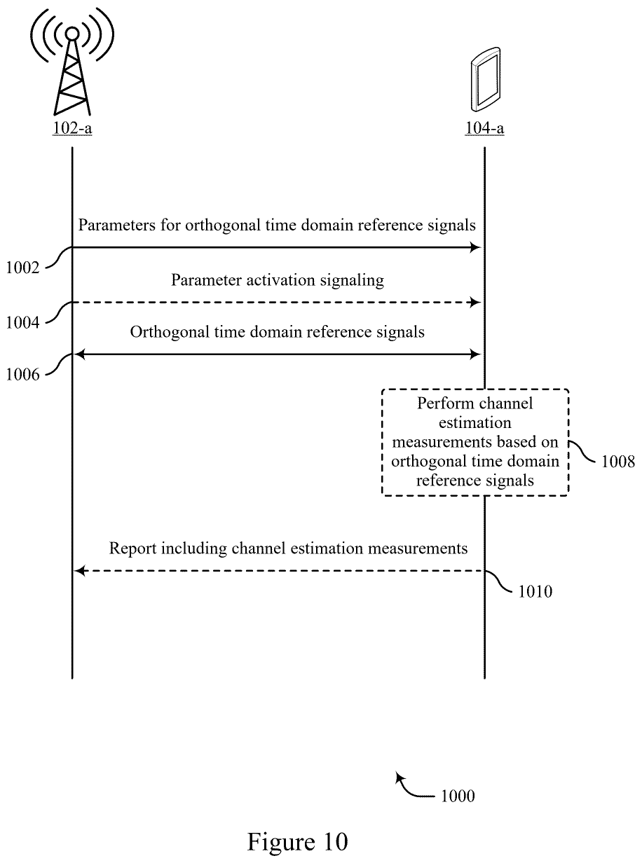

FIG. 10 illustrates an example signaling diagram 1000 in accordance with aspects of the present disclosure. In some examples, the signaling diagram 1000 implements or is implemented by aspects of the wireless communications system 100, the transmission diagram 200, the procedure 300, the transmission diagram 400, the transmission diagram 500, the transmission diagram 600, the transmission diagram 700, the transmission diagram 800, and the procedure 900. The signaling diagram 1000 may implement or be implemented by a UE 104-a and an NE 102-a, which may be examples of the corresponding devices as described with reference to FIG. 1. For example, the NE 102-a may transmit signaling that configures the UE 104-a with parameters for orthogonal time domain reference signals for channel estimation in MIMO implementations. Alternative examples of the following may be implemented, where some processes are performed in a different order than described or are not performed. In some cases, processes may include additional features not mentioned below, or further processes may be added.

At 1002, the NE 102-a transmits signaling to the UE 104-a configuring a set of parameters corresponding to one or more orthogonal time domain reference signals. The UE 104-a supports MIMO transmission and reception using an OFDM waveform. The set of parameters may include at least one of a sequence associated with the orthogonal time domain reference signals, a length of the orthogonal time domain reference signals, a length of a CP associated with a transmission including the orthogonal time domain reference signals, or a location in a symbol in the time domain corresponding to the orthogonal time domain reference signals. The length of the orthogonal time domain reference signals may be at least equal to the length of the CP. In some examples, the orthogonal time domain reference signals may be examples of DMRSs. The time domain reference signals may additionally, or alternatively, be referred to as UWs.

In some cases, at 1004, the NE 102-a transmits additional signaling to activate at least one parameter of the set of parameters. This may include activating parameters such as symbol positions in a slot or subframe associated with lengths of the orthogonal time domain reference signals, sets of code generator matrices, or sequences associated with the lengths of the orthogonal time domain reference signals. For example, the parameters may be configured at 1002 using higher layer signaling (e.g., RRC signaling), and activated dynamically and/or semi-statically at 1004 using a DCI and/or a MAC-CE.

At 1006, the UE 104-a transmits or receives symbols in the time domain including the one or more orthogonal time domain reference signals based on the set of parameters and the OFDM waveform. The symbols may span a slot in the time domain and include respective orthogonal time domain reference signals. The lengths of the reference signals may have the same value or different values. The symbols may include a fraction of symbols in a single time slot or may span a subset of time slots. The symbols may include downlink data symbols, uplink data symbols, DCI symbols, or UCI symbols. In some cases, the UE 104-a may be configured with one length of the time domain reference signals for all symbols within a slot or different lengths of the time domain reference signals in the slot.

For MIMO transmission and reception, the UE 104-a may transmit or receive respective orthogonal time domain reference signals for a set of transmit antennas based on at least one code type from a set of code types, including Barker codes, Golay codes, Zadoff-Chu sequences, and Walsh-Hadamard sequences. The set of parameters may include an indication of respective code types corresponding to the transmit antennas. The UE 104-a may select a code type for transmission and report the selected code type to the NE 102-a. Different types of sequences may be defined for different types of transmission channels, depending on coverage or use cases. For example, Golay sequences may be used for control channels, Barker sequences for data channels, or Zadoff-Chu sequences for initial access. The NE 102-a and/or the UE 104-a may use different types of sequences for different transmit antennas. For example, with four transmit antennas, the NE 102-a and/or the UE 104-a may use two different Golay sequences for two antennas and two different Barker sequences for the other two antennas.

In some cases, at 1008, if the UE 104-a receives the symbols, then the UE 104-a performs channel estimation measurements based on the orthogonal time domain reference signals. The UE 104-a may demodulate a data sequence in the received symbols using these channel estimation measurements. The UE 104-a may correlate the received signal with the known sequences to estimate the channel impulse response for each transmit antenna. For example, if Golay codes are used for time domain reference signals from two transmit antennas, the UE 104-a correlates the received signal with the first Golay code to estimate the channel impulse response of the first transmit antenna and with the second Golay code to estimate the channel impulse response of the second transmit antenna.

In some examples, at 1010, the UE 104-a transmits a report to the NE 102-a including the channel estimation measurements. In some cases, the UE 104-a may indicate in a report (e.g., CSI report) a precoding matrix to use for the time domain reference signals. If a codebook-based approach is used, then the UE 104-a may indicate an index for precoding from a look-up table, where the index may be the same or different from a PCI used for data transmission.

In some examples, orthogonal time domain reference signals associated with multiple UEs including UE 104-a may have the same code type. The set of parameters may include a pseudo-random scrambling identifier. The UE 104-a determines initialization parameters for the reference signals based on the identifier, including a distinct seed or initialization factor. The UE 104-a then initializes the orthogonal time domain reference signals with a slot number or symbol number in a frame based on these initialization parameters. Different UEs across multiple users may be based on the same sequence type, where each user is associated with a distinct seed, a distinct initialization factor, or a combination thereof.

The orthogonal time domain reference signals may include a time domain reference signal with cyclic shifts corresponding to multiple transmit antennas. In some cases, a single time domain reference signal from a look-up table of a sequence type may be used for all transmit antennas, where a cyclic shift is applied to the single time domain reference signal for each of the transmit antennas. The NE 102-a can configure a value of the cyclic shift value at the UE 104-a.

Additionally, or alternatively, the UE 104-a may receive signaling indicating to apply OCCs to the orthogonal time domain reference signals. This signaling indicates, parameters such as OCC length, OCC index, symbol index in a slot, or an indication to apply the OCC to symbols in the slot. The UE 104-a applies the OCC to the orthogonal time domain reference signals based on this signaling to obtain multi-port reference signals.

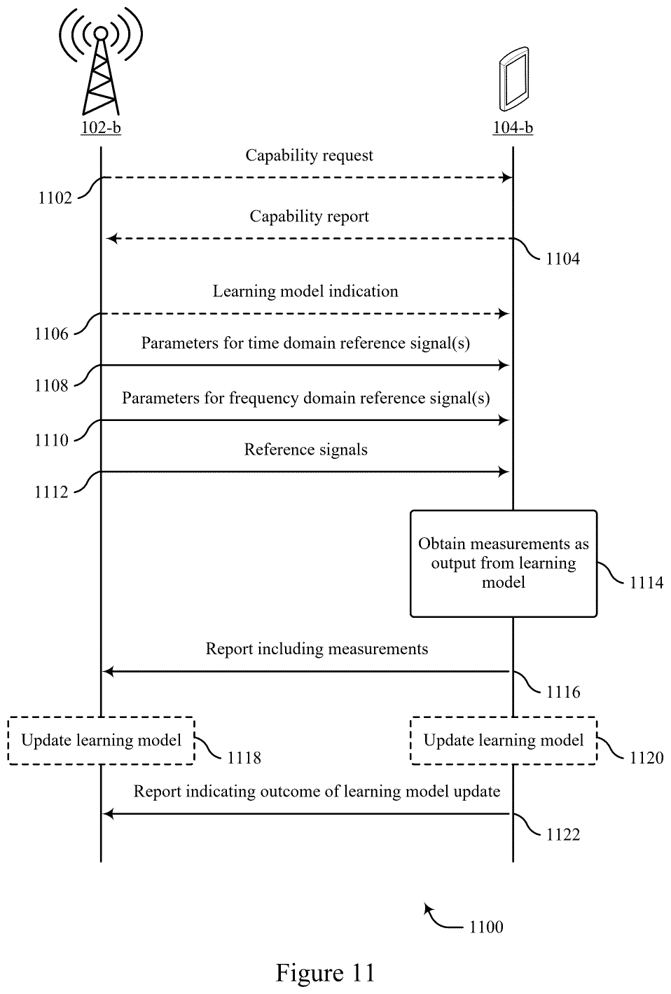

FIG. 11 illustrates an example signaling diagram 1100 in accordance with aspects of the present disclosure. In some examples, the signaling diagram 1100 implements or is implemented by aspects of the wireless communications system 100, the transmission diagram 200, the procedure 300, the transmission diagram 400, the transmission diagram 500, the transmission diagram 600, the transmission diagram 700, the transmission diagram 800, the procedure 900, and the signaling diagram 1000. The signaling diagram 1100 may implement or be implemented by a UE 104-b and an NE 102-b, which may be examples of the corresponding devices as described with reference to FIG. 1. For example, the NE 102-b may transmit signaling that configures the UE 104-b with parameters for one or more time and frequency domain reference signals for channel estimation. Alternative examples of the following may be implemented, where some processes are performed in a different order than described or are not performed. In some cases, processes may include additional features not mentioned below, or further processes may be added.

In some cases, at 1102, the NE 102-b transmits a request for a capability of the UE 104-b associated with one or more measurements. The capability may include an ability of the UE 104-b to perform different measurement types (e.g., RSRP, delay, Doppler measurements) and support processing delays for the measurement types. The request determines which measurement types can be performed or supported by the UE 104-b for different types of reference signals, including frequency domain reference signals, time domain reference signals (e.g., UWs), or a hybrid combination of frequency domain reference signals and time domain reference signals.

In some examples, at 1104, the UE 104-b transmits a capability report to the NE 102-b in response to the request. The report includes the capability of the UE 104-b related to the measurements. The UE 104-b also indicates the processing delay associated with each measurement quantity for each of the reference signal types in the capability report. The processing delay indicates to the NE 102-b about at least the minimum time window for reporting of a measurement quantity for each of the reference signal types.

In some cases, at 1106, the NE 102-b transmits signaling to the UE 104-b indicating parameters representative of a learning model (e.g., weights and biases of a learning model). Although the learning model is described in the singular, the learning model may include any numerical quantity of learning models. The learning model may be an example of an AI model and/or a ML model. The NE 102-b can perform an initial training of the learning model to obtain the parameters of the learning model, and can transmit the parameters to the UE 104-b. The UE 104-b can use the learning model to obtain one or more channel estimates.

At 1108, the NE 102-b transmits a set of parameters associated with one or more time domain reference signals to the UE 104-b. The time domain reference signals may be UWs inserted in the time domain for each OFDM symbol in a frame used as DMRS for channel estimation, where the length of DMRS may be equal to a CP duration or greater than a CP duration. The parameters may include, but are not limited to, a sequence, length, a mapping to transmit antennas for the time domain reference signals, and/or a weighting parameter for combining estimates from frequency and time domain reference signals. The UE may be configured with a single length of the time domain reference signals for all symbols within a slot or different lengths of the time domain reference signals in the slot. The parameters may also include a symbol position in a slot or subframe of time domain reference signals with differing lengths (e.g., larger lengths), a code generator matrix or an index from a set of code generator matrices to generate the of time domain reference signals with the differing lengths, and/or a sequence for the time domain reference signals with the differing lengths.

At 1110, the NE 102-b transmits a set of parameters associated with one or more frequency domain reference signals to the UE 104-b. The parameters may include, but are not limited to, an indication to use the frequency domain reference signals for channel estimation, a density of the frequency domain reference signals, a symbol position, a starting position, and/or a weighting parameter for combining estimates from frequency and time domain reference signals. Although the signaling at 1108 and at 1110 are described as being separate or different signaling, the NE 102-b can transmit a single message or signal that includes both the parameters for the time domain reference signals and the frequency domain reference signals. The frequency domain reference signals may be examples of pilot tones in the frequency domain.

At 1112, the NE 102-b transmits the time domain and frequency domain reference signals to the UE 104-b based on the parameters provided at 1108 and at 1110.

At 1114, the UE 104-b obtains measurements by providing the received parameters and reference signals as input to the learning model. The measurements may include, but are not limited to, RSRP, L1 measurements, path measurements, delay, Doppler, azimuth angle, and/or zenith angle measurements. The UE 104-b provides the frequency domain reference signal pattern and/or configuration, the time domain UW configuration, the time domain received signal at the UE (e.g., a baseband time domain signal prior to FFT), and/or the frequency domain received signal at the UE (e.g., post-FFT baseband signal at the configured frequency points) as input to the learning model. The leaning model outputs (e.g., generates) the measurements.

At 1116, the UE 104-b transmits a report including the measurements to the NE 102-b. The report may include an indication of the measurements obtained from the learning model based on time and frequency domain reference signals. The report may also include a requested set of configuration parameters for channel conditions for a measurement quantity. The NE 102-b can update the parameters using the requested set of configuration parameters.

In some cases, at 1118, the NE 102-b updates parameters of the learning model based on the received report (e.g., including one or more labeled data samples). The NE 102-b may implement supervised learning to adjust (e.g., train, fine-tune, update) the weights of the learning model by minimizing a difference between predicted and actual data samples.

In some examples, at 1120, the UE 104-b updates one or more parameters of the learning model. The UE 104-b may implement supervised learning to adjust (e.g., train, fine-tune, update) the weights of the learning model by minimizing a difference between predicted and actual data samples.

At 1122, the UE 104-b transmits a report to the NE 102-b indicating the outcome of updating the learning model parameters. The report can include new or updated parameters of the learning model.

In some cases, prior to receiving the reference signal parameters, the UE 104-b may determine and transmit parameters requesting frequency domain reference signals or specifying a weighting average parameter. The UE may indicate implicitly or explicitly in a report for the NE 102-b to include or configure frequency domain reference signals and one or more related parameters. For example, based on CSI report, the NE 102-b may determine channel conditions and include frequency domain reference signals in addition to time domain reference signals. The NE 102-b selects the parameters for the time domain reference signals and the frequency domain reference signals using the information from the UE 104-b.

The NE 102-b may transmit first signaling configuring the UE 104-b to obtain labeled data samples for the measurements based on a defined density of frequency domain reference signals. The first signaling may include an indication for the UE 104-b to store the measured labeled data samples for subsequent reference signal parameters, for learning model training, or for future reporting purposes. The UE 104-b obtains and stores the labeled data samples. The NE 102-b sends second signaling with additional parameters and an indication to update the learning model. The parameters differ from the first signaling for acquiring the labeled data samples and include reduced density frequency domain reference signals and time domain reference signals. The UE 104-b then updates the model using the new parameters and stored samples and reports the update outcome including a reference signal length parameter. The UE estimates the error of the measured quantity by using the label and learning model training estimates based on the second signaling.

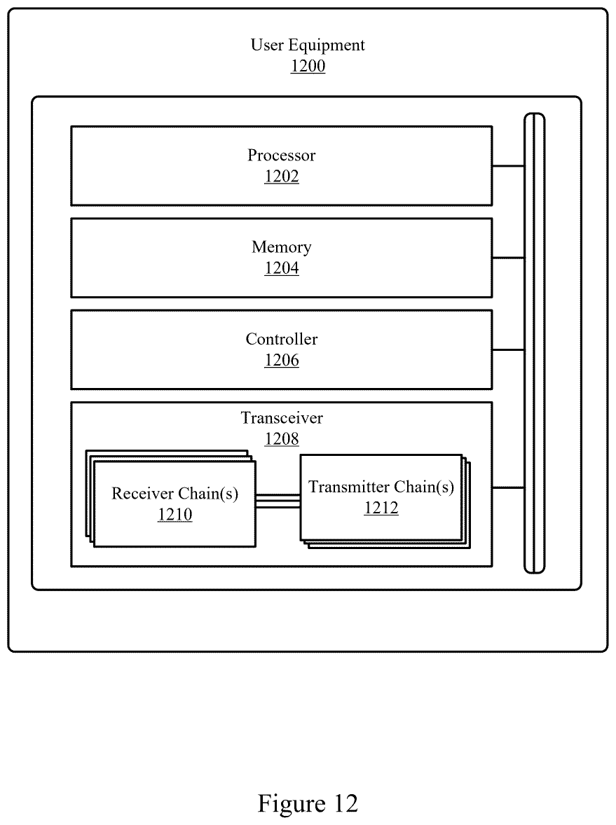

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a central processing unit (CPU), an ASIC, a field-programmable gate array (FPGA), or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving signaling configuring a set of parameters corresponding to one or more orthogonal time domain reference signals, where the UE supports MIMO transmission and reception using an OFDM waveform, and transmitting or receiving, based on the set of parameters and the OFDM waveform, symbols in a time domain including the one or more orthogonal time domain reference signals.

Additionally, the UE 1200 may be configured to support any one or combination of performing channel estimation measurements based on the one or more orthogonal time domain reference signals, where the UE 1200 receives the symbols, and transmitting a report including the channel estimation measurements. Additionally, or alternatively, the UE 1200 may be configured to support receiving the symbols, where the symbols include a data sequence, and demodulating the data sequence using the channel estimation measurements. Additionally, or alternatively, the UE 1200 may be configured to support the set of parameters includes at least one of a sequence associated with the one or more orthogonal time domain reference signals, a length associated with the one or more orthogonal time domain reference signals, a length of a CP associated with a transmission including the one or more orthogonal time domain reference signals, or a location in a symbol in the time domain corresponding to the one or more orthogonal time domain reference signals. Additionally, or alternatively, the UE 1200 may be configured to support the set of parameters includes a length of a CP, and where a length of the one or more orthogonal time domain reference signals is at least equal to the length of the CP.

Additionally, or alternatively, the UE 1200 may be configured to support the symbols include respective orthogonal time domain reference signals of the one or more orthogonal time domain reference signals, where lengths of the respective orthogonal time domain reference signals include a same value, and where the symbols span a slot in the time domain. Additionally, or alternatively, the UE 1200 may be configured to support the symbols include respective orthogonal time domain reference signals of the one or more orthogonal time domain reference signals, where lengths of the respective orthogonal time domain reference signals include different values, and where the symbols span a slot in the time domain. Additionally, or alternatively, the UE 1200 may be configured to support receiving additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals.

Additionally, or alternatively, the UE 1200 may be configured to support a set of symbols span a single time slot, where the symbols include a fraction of the set of symbols, and where the symbols include at least one of downlink data symbols, uplink data symbols, DCI symbols, or UCI symbols. Additionally, or alternatively, the UE 1200 may be configured to support the symbols span a subset of time slots of a set of time slots, and where the symbols include at least one of downlink data symbols, uplink data symbols, DCI symbols, or UCI symbols. Additionally, or alternatively, to transmit or receive the symbols including the one or more orthogonal time domain reference signals, the UE 1200 may be configured to support transmitting or receiving respective orthogonal time domain reference signals for a set of transmit antennas based on at least one code type of a set of code types, where the set of code types include of Barker codes, Golay codes, Zadoff-Chu sequences, and Walsh-Hadamard sequences. Additionally, or alternatively, the UE 1200 may be configured to support the set of parameters includes an indication of respective code types corresponding to the set of transmit antennas. Additionally, or alternatively, the UE 1200 may be configured to support the set of parameters include the set of code types and selecting a code type of the set of code types, where the symbols are transmitted based on the code type, and transmitting a report that indicates the code type.

Additionally, or alternatively, the UE 1200 may be configured to support respective orthogonal time domain reference signals associated with a set of UEs including the UE 1200 have a same code type, where the set of parameters includes a pseudo-random scrambling identifier, and determining, based on the pseudo-random scrambling identifier, a set of initialization parameters corresponding to the respective orthogonal time domain reference signals, where the set of initialization parameters includes at least one of a distinct seed or a distinct initialization factor, and initializing the one or more orthogonal time domain reference signals with at least one of a slot number in a frame or a symbol number in the frame based on the set of initialization parameters. Additionally, or alternatively, the UE 1200 may be configured to support the one or more orthogonal time domain reference signals includes a time domain reference signal associated with respective cyclic shifts corresponding to a set of transmit antennas. Additionally, or alternatively, the UE 1200 may be configured to support receiving additional signaling that indicates for the UE 1200 to apply an OCC to the one or more orthogonal time domain reference signals, where the additional signaling includes at least one of an OCC length, an OCC index, a symbol index in a slot in the time domain, or an indication to apply the OCC to one or more symbols in the slot, and applying, based on the additional signaling, the OCC to the one or more orthogonal time domain reference signals to obtain multi-port reference signals.

Additionally, or alternatively, the UE 1200 may support at least one memory (e.g., the memory 1204) and at least one processor (e.g., the processor 1202) coupled with the at least one memory and configured to cause the UE to receive signaling configuring a set of parameters corresponding to one or more orthogonal time domain reference signals, where the UE supports MIMO transmission and reception using an OFDM waveform, and transmit or receive, based on the set of parameters and the OFDM waveform, symbols in a time domain including the one or more orthogonal time domain reference signals.

Additionally, the UE 1200 may be configured to support any one or combination of to perform channel estimation measurements based on the one or more orthogonal time domain reference signals, where the UE 1200 receives the symbols, and transmit a report including the channel estimation measurements. Additionally, or alternatively, the UE 1200 may be configured to support to receive the symbols, where the symbols include a data sequence, and demodulate the data sequence using the channel estimation measurements. Additionally, or alternatively, the UE 1200 may be configured to support the set of parameters includes at least one of a sequence associated with the one or more orthogonal time domain reference signals, a length associated with the one or more orthogonal time domain reference signals, a length of a CP associated with a transmission including the one or more orthogonal time domain reference signals, or a location in a symbol in the time domain corresponding to the one or more orthogonal time domain reference signals. Additionally, or alternatively, the UE 1200 may be configured to support the set of parameters includes a length of a CP, and where a length of the one or more orthogonal time domain reference signals is at least equal to the length of the CP.

Additionally, or alternatively, the UE 1200 may be configured to support the symbols include respective orthogonal time domain reference signals of the one or more orthogonal time domain reference signals, where lengths of the respective orthogonal time domain reference signals include a same value, and where the symbols span a slot in the time domain. Additionally, or alternatively, the UE 1200 may be configured to support the symbols include respective orthogonal time domain reference signals of the one or more orthogonal time domain reference signals, where lengths of the respective orthogonal time domain reference signals include different values, and where the symbols span a slot in the time domain. Additionally, or alternatively, the UE 1200 may be configured to support to receive additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals.

Additionally, or alternatively, the UE 1200 may be configured to support a set of symbols span a single time slot, where the symbols include a fraction of the set of symbols, and where the symbols include at least one of downlink data symbols, uplink data symbols, DCI symbols, or UCI symbols. Additionally, or alternatively, the UE 1200 may be configured to support the symbols span a subset of time slots of a set of time slots, and where the symbols include at least one of downlink data symbols, uplink data symbols, DCI symbols, or UCI symbols. Additionally, or alternatively, to transmit or receive the symbols including the one or more orthogonal time domain reference signals, the UE 1200 may be configured to support to transmit or receive respective orthogonal time domain reference signals for a set of transmit antennas based on at least one code type of a set of code types, where the set of code types include of Barker codes, Golay codes, Zadoff-Chu sequences, and Walsh-Hadamard sequences. Additionally, or alternatively, the UE 1200 may be configured to support the set of parameters includes an indication of respective code types corresponding to the set of transmit antennas. Additionally, or alternatively, the UE 1200 may be configured to support the set of parameters include the set of code types and to select a code type of the set of code types, where the symbols are transmitted based on the code type, and transmit a report that indicates the code type.

Additionally, or alternatively, the UE 1200 may be configured to support respective orthogonal time domain reference signals associated with a set of UEs including the UE have a same code type, where the set of parameters includes a pseudo-random scrambling identifier, and to determine, based on the pseudo-random scrambling identifier, a set of initialization parameters corresponding to the respective orthogonal time domain reference signals, where the set of initialization parameters includes at least one of a distinct seed or a distinct initialization factor, and initialize the one or more orthogonal time domain reference signals with at least one of a slot number in a frame or a symbol number in the frame based on the set of initialization parameters. Additionally, or alternatively, the UE 1200 may be configured to support the one or more orthogonal time domain reference signals includes a time domain reference signal associated with respective cyclic shifts corresponding to a set of transmit antennas. Additionally, or alternatively, the UE 1200 may be configured to support to receive additional signaling that indicates for the UE 1200 to apply an OCC to the one or more orthogonal time domain reference signals, where the additional signaling includes at least one of an OCC length, an OCC index, a symbol index in a slot in the time domain, or an indication to apply the OCC to one or more symbols in the slot, and apply, based on the additional signaling, the OCC to the one or more orthogonal time domain reference signals to obtain multi-port reference signals.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

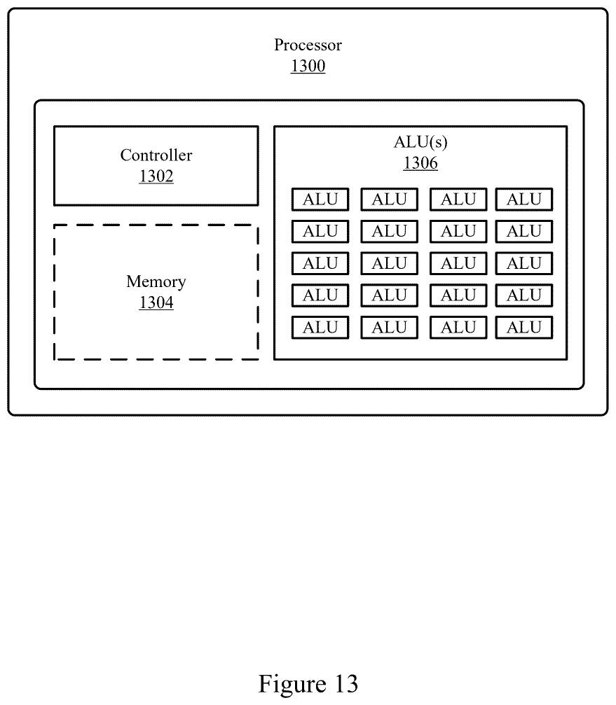

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive signaling configuring a set of parameters corresponding to one or more orthogonal time domain reference signals, where the processor supports MIMO transmission and reception using an OFDM waveform, and transmit or receive, based on the set of parameters and the OFDM waveform, symbols in a time domain including the one or more orthogonal time domain reference signals.

Additionally, the processor 1300 may be configured to or operable to support any one or combination of to perform channel estimation measurements based on the one or more orthogonal time domain reference signals, where the processor 1300 receives the symbols, and transmit a report including the channel estimation measurements. Additionally, or alternatively, the processor 1300 may be configured to support to receive the symbols, where the symbols include a data sequence, and demodulate the data sequence using the channel estimation measurements. Additionally, or alternatively, the processor 1300 may be configured to support the set of parameters includes at least one of a sequence associated with the one or more orthogonal time domain reference signals, a length associated with the one or more orthogonal time domain reference signals, a length of a CP associated with a transmission including the one or more orthogonal time domain reference signals, or a location in a symbol in the time domain corresponding to the one or more orthogonal time domain reference signals. Additionally, or alternatively, the processor 1300 may be configured to support the set of parameters includes a length of a CP, and where α length of the one or more orthogonal time domain reference signals is at least equal to the length of the CP.

Additionally, or alternatively, the processor 1300 may be configured to support the symbols include respective orthogonal time domain reference signals of the one or more orthogonal time domain reference signals, where lengths of the respective orthogonal time domain reference signals include a same value, and where the symbols span a slot in the time domain. Additionally, or alternatively, the processor 1300 may be configured to support the symbols include respective orthogonal time domain reference signals of the one or more orthogonal time domain reference signals, where lengths of the respective orthogonal time domain reference signals include different values, and where the symbols span a slot in the time domain. Additionally, or alternatively, the processor 1300 may be configured to support to receive additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals. Additionally, or alternatively, the processor 1300 may be configured to support a set of symbols span a single time slot, where the symbols include a fraction of the set of symbols, and where the symbols include at least one of downlink data symbols, uplink data symbols, DCI symbols, or UCI symbols.

Additionally, or alternatively, the processor 1300 may be configured to support the symbols span a subset of time slots of a set of time slots, and where the symbols include at least one of downlink data symbols, uplink data symbols, DCI symbols, or UCI symbols. Additionally, or alternatively, to transmit or receive the symbols including the one or more orthogonal time domain reference signals, the processor 1300 may be configured to support to transmit or receive respective orthogonal time domain reference signals for a set of transmit antennas based on at least one code type of a set of code types, where the set of code types include of Barker codes, Golay codes, Zadoff-Chu sequences, and Walsh-Hadamard sequences. Additionally, or alternatively, the processor 1300 may be configured to support the set of parameters includes an indication of respective code types corresponding to the set of transmit antennas. Additionally, or alternatively, the processor 1300 may be configured to support the set of parameters include the set of code types and to select a code type of the set of code types, where the symbols are transmitted based on the code type, and transmit a report that indicates the code type.

Additionally, or alternatively, the processor 1300 may be configured to support respective orthogonal time domain reference signals associated with a set of UEs including the processor have a same code type, where the set of parameters includes a pseudo-random scrambling identifier, and to determine, based on the pseudo-random scrambling identifier, a set of initialization parameters corresponding to the respective orthogonal time domain reference signals, where the set of initialization parameters includes at least one of a distinct seed or a distinct initialization factor, and initialize the one or more orthogonal time domain reference signals with at least one of a slot number in a frame or a symbol number in the frame based on the set of initialization parameters. Additionally, or alternatively, the processor 1300 may be configured to support the one or more orthogonal time domain reference signals includes a time domain reference signal associated with respective cyclic shifts corresponding to a set of transmit antennas. Additionally, or alternatively, the processor 1300 may be configured to support to receive additional signaling that indicates for the processor to apply an OCC to the one or more orthogonal time domain reference signals, where the additional signaling includes at least one of an OCC length, an OCC index, a symbol index in a slot in the time domain, or an indication to apply the OCC to one or more symbols in the slot, and apply, based on the additional signaling, the OCC to the one or more orthogonal time domain reference signals to obtain multi-port reference signals.

The processor 1300 may be configured to or operable to support at least one controller (e.g., the controller 1302) coupled with at least one memory (e.g., the memory 1304) and configured to cause the processor to transmit signaling configuring a set of parameters corresponding to one or more orthogonal time domain reference signals, where the processor supports MIMO transmission and reception using an OFDM waveform, and transmit or receive, based on the set of parameters and the OFDM waveform, symbols in a time domain including the one or more orthogonal time domain reference signals.

Additionally, the processor 1300 may be configured to or operable to support any one or combination of to receive a report including one or more channel estimation measurements based on the one or more orthogonal time domain reference signals, where the processor 1300 transmits the symbols. Additionally, or alternatively, the processor 1300 may be configured to support the set of parameters includes at least one of a sequence associated with the one or more orthogonal time domain reference signals, a length associated with the one or more orthogonal time domain reference signals, a length of a CP associated with a transmission including the one or more orthogonal time domain reference signals, or a location in a symbol in the time domain corresponding to the one or more orthogonal time domain reference signals. Additionally, or alternatively, the processor 1300 may be configured to support the set of parameters includes a length of a CP, and where a length of the one or more orthogonal time domain reference signals is at least equal to the length of the CP.

Additionally, or alternatively, the processor 1300 may be configured to support the symbols include respective orthogonal time domain reference signals of the one or more orthogonal time domain reference signals, where lengths of the respective orthogonal time domain reference signals include a same value, and where the symbols span a slot in the time domain. Additionally, or alternatively, the processor 1300 may be configured to support the symbols include respective orthogonal time domain reference signals of the one or more orthogonal time domain reference signals, where lengths of the respective orthogonal time domain reference signals include different values, and where the symbols span a slot in the time domain. Additionally, or alternatively, the processor 1300 may be configured to support to transmit additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals.

Additionally, or alternatively, the processor 1300 may be configured to support a set of symbols span a single time slot, where the symbols include a fraction of the set of symbols, and where the symbols include at least one of downlink data symbols, uplink data symbols, DCI symbols, or UCI symbols. Additionally, or alternatively, the processor 1300 may be configured to support the symbols span a subset of time slots of a set of time slots, and where the symbols include at least one of downlink data symbols, uplink data symbols, DCI symbols, or UCI symbols. Additionally, or alternatively, to transmit or receive the symbols including the one or more orthogonal time domain reference signals, the processor 1300 may be configured to support to transmit or receive respective orthogonal time domain reference signals for a set of transmit antennas based on at least one code type of a set of code types, where the set of code types include of Barker codes, Golay codes, Zadoff-Chu sequences, and Walsh-Hadamard sequences. Additionally, or alternatively, the processor 1300 may be configured to support the set of parameters includes an indication of respective code types corresponding to the set of transmit antennas. Additionally, or alternatively, the processor 1300 may be configured to support the set of parameters include the set of code types and to receive a report that indicates a code type of the set of code types, where the symbols are received based on the code type.

Additionally, or alternatively, the processor 1300 may be configured to support respective orthogonal time domain reference signals associated with a set of UEs have a same code type, where the set of parameters includes a pseudo-random scrambling identifier, where α set of initialization parameters corresponding to the respective orthogonal time domain reference signals are based on the pseudo-random scrambling identifier, and where the set of initialization parameters includes at least one of a distinct seed or a distinct initialization factor. Additionally, or alternatively, the processor 1300 may be configured to support the one or more orthogonal time domain reference signals includes a time domain reference signal associated with respective cyclic shifts corresponding to a set of transmit antennas. Additionally, or alternatively, the processor 1300 may be configured to support to transmit additional signaling that indicates to apply an OCC to the one or more orthogonal time domain reference signals, where the additional signaling includes at least one of an OCC length, an OCC index, a symbol index in a slot in the time domain, or an indication to apply the OCC to one or more symbols in the slot.

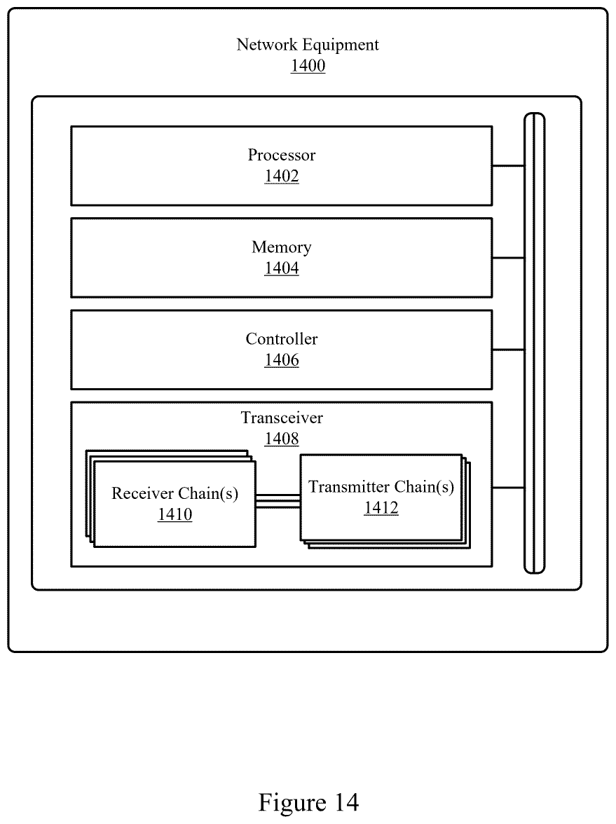

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting signaling configuring a set of parameters corresponding to one or more orthogonal time domain reference signals, where the NE supports MIMO transmission and reception using an OFDM waveform, and transmitting or receiving, based on the set of parameters and the OFDM waveform, symbols in a time domain including the one or more orthogonal time domain reference signals.

Additionally, the NE 1400 may be configured to support any one or combination of receiving a report including one or more channel estimation measurements based on the one or more orthogonal time domain reference signals, where the NE 1400 transmits the symbols. Additionally, or alternatively, the NE 1400 may be configured to support the set of parameters includes at least one of a sequence associated with the one or more orthogonal time domain reference signals, a length associated with the one or more orthogonal time domain reference signals, a length of a CP associated with a transmission including the one or more orthogonal time domain reference signals, or a location in a symbol in the time domain corresponding to the one or more orthogonal time domain reference signals. Additionally, or alternatively, the NE 1400 may be configured to support the set of parameters includes a length of a CP, and where α length of the one or more orthogonal time domain reference signals is at least equal to the length of the CP.

Additionally, or alternatively, the NE 1400 may be configured to support the symbols include respective orthogonal time domain reference signals of the one or more orthogonal time domain reference signals, where lengths of the respective orthogonal time domain reference signals include a same value, and where the symbols span a slot in the time domain. Additionally, or alternatively, the NE 1400 may be configured to support the symbols include respective orthogonal time domain reference signals of the one or more orthogonal time domain reference signals, where lengths of the respective orthogonal time domain reference signals include different values, and where the symbols span a slot in the time domain. Additionally, or alternatively, the NE 1400 may be configured to support transmitting additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals.

Additionally, or alternatively, the NE 1400 may be configured to support a set of symbols span a single time slot, where the symbols include a fraction of the set of symbols, and where the symbols include at least one of downlink data symbols, uplink data symbols, DCI symbols, or UCI symbols. Additionally, or alternatively, the NE 1400 may be configured to support the symbols span a subset of time slots of a set of time slots, and where the symbols include at least one of downlink data symbols, uplink data symbols, DCI symbols, or UCI symbols. Additionally, or alternatively, to transmit or receive the symbols including the one or more orthogonal time domain reference signals the NE 1400 may be configured to support transmitting or receiving respective orthogonal time domain reference signals for a set of transmit antennas based on at least one code type of a set of code types, where the set of code types include of Barker codes, Golay codes, Zadoff-Chu sequences, and Walsh-Hadamard sequences. Additionally, or alternatively, the NE 1400 may be configured to support the set of parameters includes an indication of respective code types corresponding to the set of transmit antennas. Additionally, or alternatively, the NE 1400 may be configured to support the set of parameters include the set of code types and receiving a report that indicates a code type of the set of code types, where the symbols are received based on the code type.

Additionally, or alternatively, the NE 1400 may be configured to support respective orthogonal time domain reference signals associated with a set of UEs have a same code type, where the set of parameters includes a pseudo-random scrambling identifier, where α set of initialization parameters corresponding to the respective orthogonal time domain reference signals are based on the pseudo-random scrambling identifier, and where the set of initialization parameters includes at least one of a distinct seed or a distinct initialization factor. Additionally, or alternatively, the NE 1400 may be configured to support the one or more orthogonal time domain reference signals includes a time domain reference signal associated with respective cyclic shifts corresponding to a set of transmit antennas. Additionally, or alternatively, the NE 1400 may be configured to support transmitting additional signaling that indicates to apply an OCC to the one or more orthogonal time domain reference signals, where the additional signaling includes at least one of an OCC length, an OCC index, a symbol index in a slot in the time domain, or an indication to apply the OCC to one or more symbols in the slot.

Additionally, or alternatively, the NE 1400 may support at least one memory (e.g., the memory 1404) and at least one processor (e.g., the processor 1402) coupled with the at least one memory and configured to cause the NE to transmit signaling configuring a set of parameters corresponding to one or more orthogonal time domain reference signals, where the NE supports MIMO transmission and reception using an OFDM waveform, and transmit or receive, based on the set of parameters and the OFDM waveform, symbols in a time domain including the one or more orthogonal time domain reference signals.

Additionally, the NE 1400 may be configured to support any one or combination of to receive a report including one or more channel estimation measurements based on the one or more orthogonal time domain reference signals, where the NE transmits the symbols. Additionally, or alternatively, the NE 1400 may be configured to support the set of parameters includes at least one of a sequence associated with the one or more orthogonal time domain reference signals, a length associated with the one or more orthogonal time domain reference signals, a length of a CP associated with a transmission including the one or more orthogonal time domain reference signals, or a location in a symbol in the time domain corresponding to the one or more orthogonal time domain reference signals. Additionally, or alternatively, the NE 1400 may be configured to support the set of parameters includes a length of a CP, and where α length of the one or more orthogonal time domain reference signals is at least equal to the length of the CP.

Additionally, or alternatively, the NE 1400 may be configured to support the symbols include respective orthogonal time domain reference signals of the one or more orthogonal time domain reference signals, where lengths of the respective orthogonal time domain reference signals include a same value, and where the symbols span a slot in the time domain. Additionally, or alternatively, the NE 1400 may be configured to support the symbols include respective orthogonal time domain reference signals of the one or more orthogonal time domain reference signals, where lengths of the respective orthogonal time domain reference signals include different values, and where the symbols span a slot in the time domain. Additionally, or alternatively, the NE 1400 may be configured to support to transmit additional signaling that activates at least one parameter of the set of parameters, where the set of parameters includes at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals.

Additionally, or alternatively, the NE 1400 may be configured to support a set of symbols span a single time slot, where the symbols include a fraction of the set of symbols, and where the symbols include at least one of downlink data symbols, uplink data symbols, DCI symbols, or UCI symbols. Additionally, or alternatively, the NE 1400 may be configured to support the symbols span a subset of time slots of a set of time slots, and where the symbols include at least one of downlink data symbols, uplink data symbols, DCI symbols, or UCI symbols. Additionally, or alternatively, to transmit or receive the symbols including the one or more orthogonal time domain reference signals, the NE 1400 may be configured to support to transmit or receive respective orthogonal time domain reference signals for a set of transmit antennas based on at least one code type of a set of code types, where the set of code types include of Barker codes, Golay codes, Zadoff-Chu sequences, and Walsh-Hadamard sequences. Additionally, or alternatively, the NE 1400 may be configured to support the set of parameters includes an indication of respective code types corresponding to the set of transmit antennas. Additionally, or alternatively, the NE 1400 may be configured to support the set of parameters include the set of code types and to receive a report that indicates a code type of the set of code types, where the symbols are received based on the code type.

Additionally, or alternatively, the NE 1400 may be configured to support respective orthogonal time domain reference signals associated with a set of UEs have a same code type, where the set of parameters includes a pseudo-random scrambling identifier, where α set of initialization parameters corresponding to the respective orthogonal time domain reference signals are based on the pseudo-random scrambling identifier, and where the set of initialization parameters includes at least one of a distinct seed or a distinct initialization factor. Additionally, or alternatively, the NE 1400 may be configured to support the one or more orthogonal time domain reference signals includes a time domain reference signal associated with respective cyclic shifts corresponding to a set of transmit antennas. Additionally, or alternatively, the NE 1400 may be configured to support to transmit additional signaling that indicates to apply an OCC to the one or more orthogonal time domain reference signals, where the additional signaling includes at least one of an OCC length, an OCC index, a symbol index in a slot in the time domain, or an indication to apply the OCC to one or more symbols in the slot.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., an LNA) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

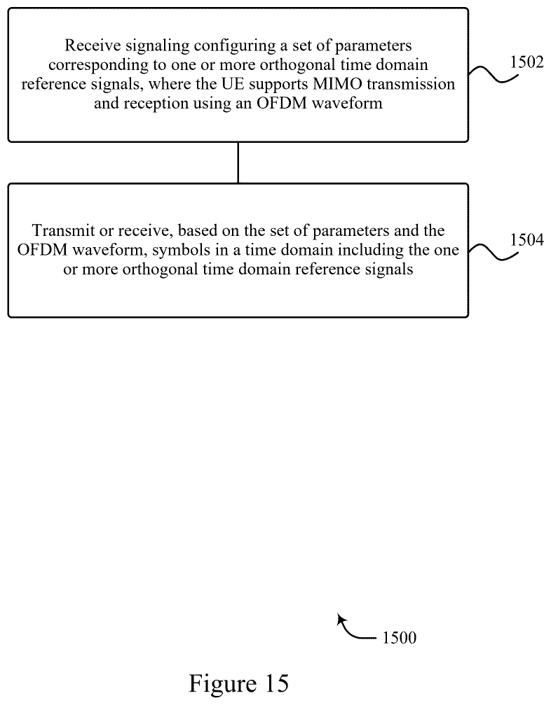

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving signaling configuring a set of parameters corresponding to one or more orthogonal time domain reference signals, where the UE supports MIMO transmission and reception using an OFDM waveform. The operations of 1502 may be performed in accordance with examples as described herein. In some implementations, aspects of the operations of 1502 may be performed by a UE as described with reference to FIG. 12.

At 1504, the method may include transmitting or receiving, based on the set of parameters and the OFDM waveform, symbols in a time domain including the one or more orthogonal time domain reference signals. The operations of 1504 may be performed in accordance with examples as described herein. In some implementations, aspects of the operations of 1504 may be performed by a UE as described with reference to FIG. 12.

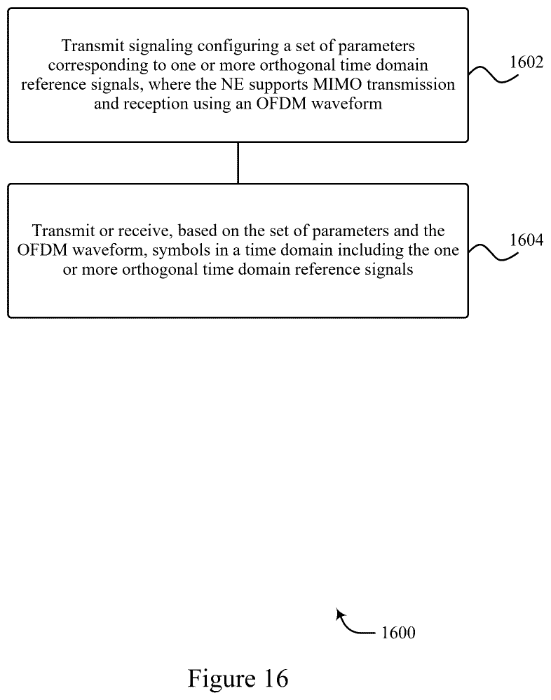

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting signaling configuring a set of parameters corresponding to one or more orthogonal time domain reference signals, where the NE supports MIMO transmission and reception using an OFDM waveform. The operations of 1602 may be performed in accordance with examples as described herein. In some implementations, aspects of the operations of 1602 may be performed by an NE as described with reference to FIG. 14.

At 1604, the method may include transmitting or receiving, based on the set of parameters and the OFDM waveform, symbols in a time domain including the one or more orthogonal time domain reference signals. The operations of 1604 may be performed in accordance with examples as described herein. In some implementations, aspects of the operations of 1604 may be performed by an NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling configuring a plurality of parameters corresponding to one or more orthogonal time domain reference signals, wherein the UE supports multiple input multiple output (MIMO) transmission and reception using an orthogonal frequency division multiplexing (OFDM) waveform; and
transmit or receive, based at least in part on the plurality of parameters and the OFDM waveform, symbols in a time domain comprising the one or more orthogonal time domain reference signals.

2. The UE of claim 1, wherein the at least one processor is further operable to cause the UE to:
perform channel estimation measurements based at least in part on the one or more orthogonal time domain reference signals, wherein the UE receives the symbols;
transmit a report comprising the channel estimation measurements, wherein the UE receives the symbols, and wherein the symbols comprise a data sequence; and
demodulate the data sequence using the channel estimation measurements.

3. The UE of claim 1, wherein the plurality of parameters comprises at least one of a sequence associated with the one or more orthogonal time domain reference signals, a length associated with the one or more orthogonal time domain reference signals, a length of a cyclic prefix (CP) associated with a transmission comprising the one or more orthogonal time domain reference signals, or a location in a symbol in the time domain corresponding to the one or more orthogonal time domain reference signals.

4. The UE of claim 1, wherein the plurality of parameters comprises a length of a cyclic prefix (CP), and wherein a length of the one or more orthogonal time domain reference signals is at least equal to the length of the CP.

5. The UE of claim 1, wherein the symbols comprise respective orthogonal time domain reference signals of the one or more orthogonal time domain reference signals, wherein lengths of the respective orthogonal time domain reference signals comprise a same value, and wherein the symbols span a slot in the time domain.

6. The UE of claim 1, wherein the symbols comprise respective orthogonal time domain reference signals of the one or more orthogonal time domain reference signals, wherein lengths of the respective orthogonal time domain reference signals comprise different values, wherein the symbols span a slot in the time domain, and wherein the at least one processor is further operable to cause the UE to receive additional signaling that activates at least one parameter of the plurality of parameters, wherein the plurality of parameters comprises at least one of one or more symbol positions in the slot or in a subframe associated with the lengths of the respective orthogonal time domain reference signals, one or more sets of code generator matrices associated with the lengths of the respective orthogonal time domain reference signals, or one or more sequences associated with the lengths of the respective orthogonal time domain reference signals.

7. The UE of claim 1, wherein a plurality of symbols spans a single time slot, wherein the symbols comprise a fraction of the plurality of symbols, and wherein the symbols comprise at least one of downlink data symbols, uplink data symbols, downlink control information (DCI) symbols, or uplink control information (UCI) symbols.

8. The UE of claim 1, wherein the symbols span a subset of time slots of a plurality of time slots, and wherein the symbols comprise at least one of downlink data symbols, uplink data symbols, downlink control information (DCI) symbols, or uplink control information (UCI) symbols.

9. The UE of claim 1, wherein to transmit or receive the symbols comprising the one or more orthogonal time domain reference signals, the at least one processor is operable to cause the UE to transmit or receive respective orthogonal time domain reference signals for a plurality of transmit antennas based at least in part on at least one code type of a plurality of code types, wherein the plurality of code types comprise of Barker codes, Golay codes, Zadoff-Chu sequences, and Walsh-Hadamard sequences.

10. The UE of claim 9, wherein the plurality of parameters comprises an indication of respective code types corresponding to the plurality of transmit antennas.

11. The UE of claim 9, wherein the plurality of parameters comprises the plurality of code types, and wherein the at least one processor is further operable to cause the UE to:
select a code type of the plurality of code types, wherein the symbols are transmitted based at least in part on the code type; and
transmit a report that indicates the code type.

12. The UE of claim 1, wherein respective orthogonal time domain reference signals associated with a plurality of UEs comprising the UE have a same code type, wherein the plurality of parameters comprises a pseudo-random scrambling identifier, and wherein the at least one processor is further operable to cause the UE to:
determine, based at least in part on the pseudo-random scrambling identifier, a plurality of initialization parameters corresponding to the respective orthogonal time domain reference signals, wherein the plurality of initialization parameters comprises at least one of a distinct seed or a distinct initialization factor; and
initialize the one or more orthogonal time domain reference signals with at least one of a slot number in a frame or a symbol number in the frame based at least in part on the plurality of initialization parameters.

13. The UE of claim 1, wherein the one or more orthogonal time domain reference signals comprises a time domain reference signal associated with respective cyclic shifts corresponding to a plurality of transmit antennas.

14. The UE of claim 1, wherein the at least one processor is further operable to cause the UE to:
receive additional signaling that indicates for the UE to apply an orthogonal cover code (OCC) to the one or more orthogonal time domain reference signals, wherein the additional signaling comprises at least one of an OCC length, an OCC index, a symbol index in a slot in the time domain, or an indication to apply the OCC to one or more symbols in the slot; and
apply, based at least in part on the additional signaling, the OCC to the one or more orthogonal time domain reference signals to obtain multi-port reference signals.

15. A method performed by a user equipment (UE), the method comprising:
receiving signaling configuring a plurality of parameters corresponding to one or more orthogonal time domain reference signals, wherein the UE supports multiple input multiple output (MIMO) transmission and reception using an orthogonal frequency division multiplexing (OFDM) waveform; and
transmitting or receiving, based at least in part on the plurality of parameters and the OFDM waveform, symbols in a time domain comprising the one or more orthogonal time domain reference signals.

16. A network equipment (NE) for wireless communication, comprising:
at least one memory; and
at least one processor coupled with the at least one memory and operable to cause the NE to:
transmit signaling configuring a plurality of parameters corresponding to one or more orthogonal time domain reference signals, wherein the NE supports multiple input multiple output (MIMO) transmission and reception using an orthogonal frequency division multiplexing (OFDM) waveform; and
transmit or receive, based at least in part on the plurality of parameters and the OFDM waveform, symbols in a time domain comprising the one or more orthogonal time domain reference signals.

17. The NE of claim 16, wherein the at least one processor is further operable to cause the NE to receive a report comprising one or more channel estimation measurements based at least in part on the one or more orthogonal time domain reference signals, wherein the NE transmits the symbols.

18. The NE of claim 16, wherein the plurality of parameters comprises at least one of a sequence associated with the one or more orthogonal time domain reference signals, a length associated with the one or more orthogonal time domain reference signals, a length of a cyclic prefix (CP) associated with a transmission comprising the one or more orthogonal time domain reference signals, or a location in a symbol in the time domain corresponding to the one or more orthogonal time domain reference signals.

19. The NE of claim 16, wherein the plurality of parameters comprises a length of a cyclic prefix (CP), and wherein a length of the one or more orthogonal time domain reference signals is at least equal to the length of the CP.

20. A method performed by a network equipment (NE), the method comprising:
transmitting signaling configuring a plurality of parameters corresponding to one or more orthogonal time domain reference signals, wherein the NE supports multiple input multiple output (MIMO) transmission and reception using an orthogonal frequency division multiplexing (OFDM) waveform; and
transmitting or receiving, based at least in part on the plurality of parameters and the OFDM waveform, symbols in a time domain comprising the one or more orthogonal time domain reference signals.
